(19) United States
(12) Patent Application Publication
(10) Pub. No.: US 2012/0007963 A1
(43) Pub. Date: Jan. 12, 2012

(54) ILLUMINATION CONTROLLER, ILLUMINATOR AND ILLUMINATION SYSTEM USING ILLUMINATION CONTROLLER, AND DISPLAY DEVICE AND EYEGLASS DEVICE FOR USE WITH ILLUMINATION CONTROLLER

(76) Inventor: Koichi MATSUMURA, Osaka (JP)

(21) Appl. No.: 13/238,711

(22) Filed: Sep. 21, 2011

Related U.S. Application Data
(63) Continuation of application No. PCT/JP2011/001301, filed on Mar. 4, 2011.

(30) Foreign Application Priority Data
Mar. 5, 2010 (JP) 2010-049836

(51) Int. Cl. H04N 13/04

(52) U.S. Cl. 348/51; 348/E13.075

(57) ABSTRACT

An illumination controller including: an acquisition portion for acquiring timing information on a timing of a non-display period during which a display device switches a frame image of a stereoscopic video without displaying the frame image; and a control portion for brightening a light source configured to illuminate a space where the display device is situated in synchronism with the non-display period and for darkening the light source in synchronism with a display period during which the frame image is displayed, based on the timing information.

### TECHNICAL FIELD

The present invention is related to an illumination controller for providing a suitable illumination environment to viewers viewing stereoscopic videos and other users, an illuminator and an illumination system using the illumination controller, and a display device and an eyeglass device for use with the illumination controller.

### BACKGROUND ART

Recent developments in video technologies have provided a video system configured to display a video to be stereoscopically perceived by viewers (stereoscopic video). In many cases, a display device displays a left frame images to be viewed by the left eye and a right frame images to be viewed by the right eye. The viewer wears an eyeglass device configured to perform stereoscopic vision assistance to make the viewer perceive the left and right frame images as a stereoscopic video shown on the display device. Under the stereoscopic vision assistance of the eyeglass device, the viewer views the left frame images by the left eye and the right frame images by the right eye. As a result, the viewer may stereoscopically perceive the video shown by the display device.

Patent Document 1 discloses a video system configured to allow a video displayed by a display device to be stereoscopically perceived in use of an eyeglass device. The video system of Patent Document 1 includes the eyeglass device with a light source configured to illuminate a space between optical shutters to adjust a light amount from the video and the viewer's eyes. In accordance with the disclosed technologies of Patent Document 1, while a left frame image is displayed (i.e., while the optical shutter for the right eye is closed), the light source for illuminating the space between the right eye and the optical shutter for the right eye is turned on. While a right frame image is displayed (i.e., while the optical shutter for the left eye is closed), the light source for illuminating the space between the left eye and the optical shutter for the left eye is turned on. Thus, the disclosed technologies of Patent Document 1 cause less variation in light amount in the space between the optical shutters and the viewer's eyes, which results in little flicker.

It is known that a dark surrounding environment, in which a video is viewed, is generally preferable like a cinema house. It should be noted that the light source of the eyeglass device of Patent Document 1 is situated nearby the viewer's eyes to adjust a degree of the brightness/darkness of the small limited space between the viewer's eyes and the optical shutters. Thus, the light source does not aim to adjust the degree of brightness/darkness of a large space where a display device is situated.

A viewer in a dark space where a display device is situated may watch a vivid video. The dark space results in an enhanced contrast between the surrounding environment and a video even if the display device reduces a luminance of the display portion configured to display the video, which contributes to less power consumption of the display device.

A dark space where a display device is situated may be preferable for a viewer as described above whereas the dark space is not preferable for other users (hereinafter referred to as users) who do not view a video. For example, the dark space is inconvenient for the users to read.
Patent Document 1: Japanese Unexamined Utility Model Application Publication No. H5-20480

### SUMMARY OF THE INVENTION

An object of the present invention is to provide an illumination controller for providing a suitable illumination environment to viewers viewing a stereoscopic video and other users, an illuminator and an illumination system which utilizes the illumination controller, and a display device and an eyeglass device which are used with the illumination controller.

An illumination controller in accordance with one aspect of the present invention is characterized by including an acquisition portion configured to acquire timing information on a timing of a non-display period during which a display device switches a frame image of a stereoscopic video without displaying the frame image; and a control portion configured to brighten a light source for illuminating a space where the display device is situated in synchronism with the non-display period and to darken the light source in synchronism with a display period during which the frame image is displayed, based on the timing information.

An illuminator in accordance with another aspect of the present invention is characterized by including a light source configured to illuminate a space where a display device for displaying a stereoscopic video is situated, and the aforementioned illumination controller.

An illumination system in accordance with yet another aspect of the present invention is characterized by including a display device including a display portion configured to display a stereoscopic video, and the aforementioned illuminator.

A display device in accordance with yet another aspect of the present invention is characterized by including a display portion configured to display a stereoscopic video, and a first transmitter configured to send a synchronization signal to the illumination controller in order to control a light source for illuminating a space where the display device is situated, so that the light source is brightened in synchronism with a non-display period during which a frame image of the stereoscopic video is switched without being displayed whereas the light source is darkened in synchronism with a display period during which the frame image is displayed.

An eyeglass device in accordance with yet another aspect of the present invention is characterized by including an optical filter portion configured to perform stereoscopic vision assistance to adjust a light amount transmitted to an eye of a viewer in synchronism with display of a frame image of a stereoscopic video displayed by a display device so as to allow the viewer to stereoscopically perceive the stereoscopic video, wherein the optical filter portion increases the light amount transmitted to the viewer's eye in synchronism with a timing at which the illumination controller darkens the light source.

### BRIEF DESCRIPTION OF THE DRAWINGS

FIG. 1 is a schematic view of an illumination system and an eyeglass device in accordance with the first embodiment.

FIG. 2 is a schematic view showing a synchronous operation among a display device, an illuminator of the illumination system and the eyeglass device shown in FIG. 1.

FIG. 3 is a block diagram schematically showing a hardware configuration of the display device of the illumination system shown in FIG. 1.

FIG. 4 is a block diagram schematically showing a functional configuration of the display device shown in FIG. 3.

FIG. 5 is a block diagram schematically showing a hardware configuration of the illuminator of the illumination system shown in FIG. 1.

FIG. 6 is a block diagram schematically showing a functional configuration of the illuminator shown in FIG. 5.

FIG. 7 is a block diagram schematically showing a hardware configuration of the eyeglass device shown in FIG. 1.

FIG. 8 is a block diagram schematically showing a functional configuration of the eyeglass device shown in FIG. 7.

FIG. 9 is a timing chart schematically showing a blinking control of the illumination system shown in FIG. 1.

FIG. 10 is a timing chart schematically showing a control for stereoscopic vision assistance of the eyeglass device shown in FIG. 1.

FIG. 11 is a timing chart schematically showing a blinking control of an illumination system in accordance with the second embodiment.

FIG. 12 is a timing chart schematically showing a control for stereoscopic vision assistance of an eyeglass device in accordance with the second embodiment.

FIG. 13 shows exemplary waveform patterns of synchronization signals used for a blinking control of an illumination system in accordance with the third embodiment.

FIG. 14 is a table showing information assigned to the synchronization signals shown in FIG. 13.

FIG. 15 is a timing chart schematically showing the blinking control of the illumination system by means of the synchronization signals shown in FIG. 13.

FIG. 16 is a timing chart schematically showing a control for stereoscopic vision assistance of an eyeglass device by means of the synchronization signals shown in FIG. 13.

FIG. 17 is a table showing information assigned to synchronization signals used for a blinking control of an illumination system in accordance with the fourth embodiment.

FIG. 18 is a timing chart schematically showing the blinking control of the illumination system by means of the synchronization signals shown in FIG. 17.

FIG. 19 is a timing chart schematically showing a control for stereoscopic vision assistance of an eyeglass device by means of the synchronization signals shown in FIG. 17.

FIG. 20 is a schematic view of an illumination system and an eyeglass device in accordance with the fifth embodiment.

FIG. 21 is a block diagram schematically showing a hardware configuration of the eyeglass device shown in FIG. 20.

FIG. 22 is a block diagram schematically showing a functional configuration of the eyeglass device shown in FIG. 21.

FIG. 23 is a timing chart schematically showing a control for stereoscopic vision assistance of the eyeglass device shown in FIG. 20.

FIG. 24 is a timing chart schematically showing a blinking control of the illumination system shown in FIG. 20.

FIG. 25 is a schematic view of an illumination system and an eyeglass device in accordance with the sixth embodiment.

FIG. 26 is a block diagram schematically showing a hardware configuration of a display device of the illumination system shown in FIG. 25.

FIG. 27 is a block diagram schematically showing a functional configuration of the display device shown in FIG. 26.

FIG. 28 is a timing chart schematically showing a blinking control of the illumination system shown in FIG. 25.

FIG. 29 is a schematic view of an illumination system and an eyeglass device in accordance with the seventh embodiment.

FIG. 30 is a block diagram schematically showing a hardware configuration of an illuminator of the illumination system shown in FIG. 29.

FIG. 31 is a block diagram schematically showing a functional configuration of the illuminator shown in FIG. 30.

FIG. 32 is a timing chart schematically showing a blinking control of the illumination system and a control for stereoscopic vision assistance of the eyeglass device shown in FIG. 29.

FIG. 33 is a timing chart schematically showing a blinking control of an illumination system and a control for stereoscopic vision assistance of an eyeglass device in accordance with the eighth embodiment.

### DESCRIPTION OF THE INVENTION

An illumination controller, an illuminator, an illumination system, a display device and an eyeglass device in accordance with one embodiment are described hereinafter by reference to the accompanying drawings. It should be noted that configurations, positions or shapes shown in the drawings as well as descriptions related to the drawings are merely provided for a purpose of facilitating to understand principles of the illumination controller, the illuminator, the illumination system, the display device and the eyeglass device without limiting the principles in any way.

### First Embodiment

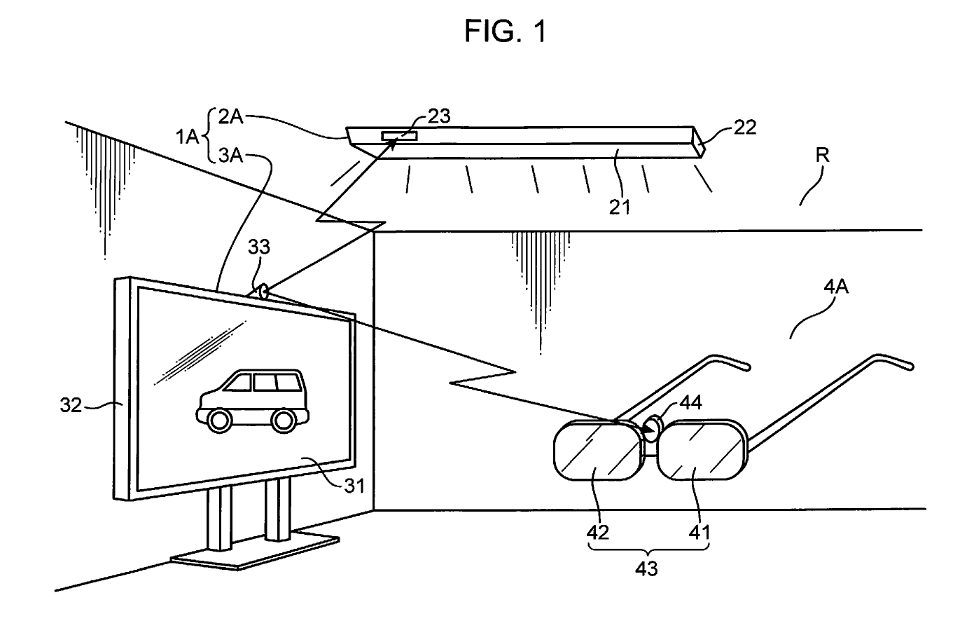

FIG. 1 schematically shows an illumination system and an eyeglass device in accordance with the first embodiment. An illumination controller is integrated into an illuminator of the illumination system shown in FIG. 1. The eyeglass device is used to assist in viewing a stereoscopic video displayed by a display device of the illumination system.

The illumination system 1A includes the illuminator 2A and the display device 3A. The illuminator 2A illuminates a space R in which the display device 3A is placed. The illuminator 2A shown in FIG. 1 is mounted to the ceiling which defines the space R, but may be mounted to the sidewalls or the floor. The illuminator 2A includes a light source 21 configured to illuminate the space R. The light source 21 is brightened in synchronism with switching of frame images of the stereoscopic video displayed by the display device 3A and is darkened in synchronism with display of the frame image, under control of the illumination controller integrated in the illuminator 2A. In the present embodiment, an LED (Light Emitting Diode) is preferably used as the light source 21. Alternatively, another light emitter configured to blink according to a frame rate of the display device 3A may be used as the light source 21.

The display device 3A includes a display panel 31 used as the display portion configured to display stereoscopic videos. A CRT display, liquid crystal display, PDP (plasma display panels), organic electroluminescence display or another device configured to display videos are preferably used as the display panel 31. The video displayed by the display panel 31 includes left frame images created or depicted so as to be viewed by the left eye, and right frame images created or depicted so as to be viewed by the right eye. In the present embodiment, the left and right frame images are alternately displayed on the display panel 31.

The eyeglass device 4A executes stereoscopic vision assistance so that a viewer views the left frame images by the left eye and the right frame images by the right eye. As a result, the viewer three-dimensionally (stereoscopically) perceives the video displayed on the display panel 31. If a video is stereoscopically perceived, objects in the left and right frame images (the image of the objects depicted in the left and right frame images) is perceived as if it projects or retreats from the flat surface of the display panel 31.

The eyeglass device 4A looks like a vision correction eyeglasses. The eyeglass device 4A includes an optical filter portion 43 including a left filter 41 situated in front of the viewer's left eye wearing the eyeglass device 4A, and a right filter 42 situated in front of the right eye. The left and right filters 41, 42 are optical elements configured to adjust a light amount transmitted to the left and right eyes of the viewer, respectively. Therefore, shutter elements (e.g., liquid crystal shutters) configured to open and close a light path toward the left and right eyes of the viewer, deflection elements (e.g., liquid crystal filters) configured to deflect the light transmitted to the left and right eyes of the viewer, and other optical elements configured to adjust the transmitted light amount are preferably used as the left and right filters 41, 42. If a left frame image is displayed on the display panel 31, the optical filter portion 43 increases the light amount which reaches the left eye through the left filter 41 whereas the optical filter portion 43 decreases the light amount which reaches the right eye through the right filter 42. If a right frame image is displayed on the display panel 31, the optical filter portion 43 increases the light amount which reaches the right eye through the right filter 42 whereas the optical filter portion 43 decreases the light amount which reaches the left eye through the left filter 41. Thus, the viewer may view the left frame image by the left eye and the right frame image by the right eye under the stereoscopic vision assistance by the optical filter portion 43, so that the viewer may stereoscopically perceive the stereoscopic video displayed on the display panel 31.

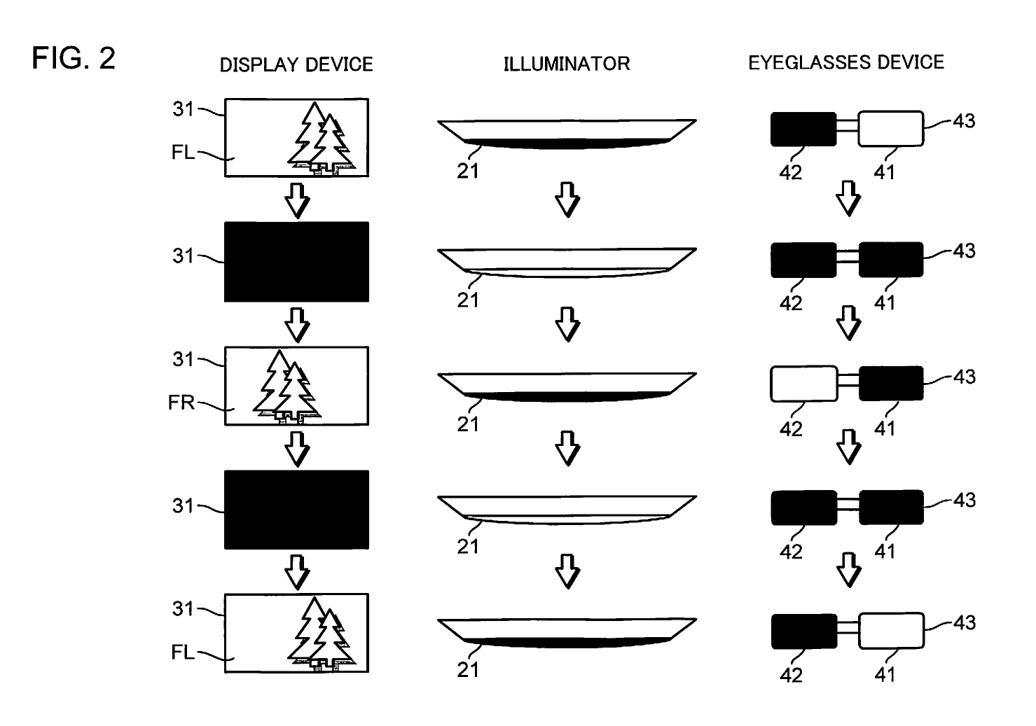

FIG. 2 schematically shows operations of the display device 3A, the illuminator 2A and the eyeglass device 4A. An operational correlation among the display device 3A, the illuminator 2A and the eyeglass device 4A is described with reference to FIGS. 1 and 2.

The display panel 31 of the display device 3A alternately displays left and right frame images FL, FR. In the following descriptions, the period during which the left or right frame image FL, FR is displayed, for convenience, is referred to as the display period. The period during which the left or right frame image FL, FR is switched to the right or left frame image FR, FL is referred to as the non-display period during which the frame images FL, FR are not displayed. The display panel 31 temporarily does not display the frame images FL, FR, which results in a decreased luminance of the display panel 31.

While the left or right frame image FL, FR is displayed on the display panel 31, the light source 21 of the illuminator 2A is brightened. While the left or right frame image FL, FR is switched to the right or left frame image FR, FL (i.e., the non-display period in which the frame images FL, FR are not displayed on the display panel 31), the light source 21 is darkened.

While the left frame image FL is displayed on the display panel 31, the optical filter portion 43 increases a light amount which reaches the left eye through the left filter 41 whereas the optical filter portion 43 decreases the light amount which reaches the right eye through the right filter 42. While the right frame image FR is displayed on the display panel 31, the optical filter portion 43 increases the light amount which reaches the right eye through the right filter 42 whereas the optical filter portion decreases the light amount which reaches the left eye through the left filter 41. While the left or right frame image FL, FR is switched to the right or left frame image FR, FL (i.e., the non-display period in which a frame image is not displayed on the display panel 31), the optical filter portion 43 coincidentally decreases the light amount which passes through the left and right filters 41, 42.

As shown in FIG. 1, the display device 3A includes a transmission device 33 situated on an upper edge of a housing 32 which surrounds the periphery of the rectangular display panel 31. The transmission device 33 is used as a first tramsmitter configured to transmit synchronization signals in synchronism with displays of the left and right frame images FL, FR on the display panel 31. An RF transmitter, an infrared emitter or another element configured to transmit the synchronization signals is preferably exemplified as the transmission device 33.

The illuminator 2A includes a reception device 23 appeared on the outer surface of a housing 22, which is mounted to the ceiling of the space R to support the light source 21. The reception device 23 is used as a receiver configured to receive a synchronization signal from the transmission device 33. If an RF transmitter is used as the transmission device 33, an RF receiver is preferably used as the reception device 23. If an infrared-emitter is used as the transmission device 33, an infrared reception device is preferably used as the reception device 23. Alternatively, anther element configured to receive a synchronization signal sent from the transmission device 33 may be used as the reception device 23. In the present embodiment, the synchronization signals are transmitted to the illumination controller integrated in the illuminator 2A for transmitting timing information on timings of the non-display periods, during which the switching operation between the left and right frame images FL, FR is performed as described in the context of FIG. 2. The reception device 23 is used as an acquisition portion configured to acquire the timing information on the timing of the non-display period, during which the switching operation between the left and right frame images FL, FR is performed.

The eyeglass device 4A includes a reception device 44 situated between the left and right filters 41, 42. The reception device 44 is used as a receiver of the synchronization signals like the reception device 23 of the illuminator 2A. The reception device 44 receives the synchronization signal, which is transmitted from the transmission device, to achieve synchronization between the display of the frame images FL, FR of the stereoscopic video and the stereoscopic vision assistance of the optical filter portion 43. If an RF transmitter is used as the transmission device 33, an RF receiver is preferably used as the reception device 44. If an infrared-emitter is used as the transmission device 33, an infrared reception device is preferably used as the reception device 44. Alternatively, another element configured to receive the synchronization signal sent by the transmission device 33 may be used as the reception device 44.

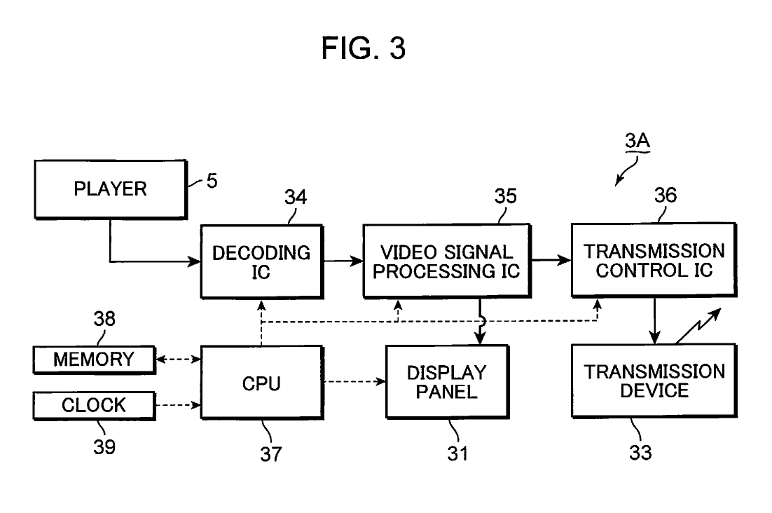

FIG. 3 is a block diagram schematically showing a hardware configuration of the display device 3A. The display device 3A is described with reference to FIGS. 1 to 3.

The display device 3A includes a decoding IC 34, a video signal processing IC 35, a transmission control IC 36, a CPU 37, a memory 38 and a clock 39, in addition to the display panel 31 and the transmission device 33.

In the present embodiment, a player 5 plays contents data of a stereoscopic video to supply video signals of the stereoscopic video to the display device 3A. Alternatively, the video signals of the stereoscopic video may be supplied to the display device 3A through the Internet, a station which sends broadcast waves or other external devices. The player 5 plays the contents data to input encoded video signals and information included in a header of the contents data (e.g., information on a frame rate and a display time period per frame image) to the decoding IC 34 of the display device 3A. The decoding IC 34 decodes the video signal to output video data in a prescribed format. The video signal may be encoded according to a method of MPEG (Motion Picture Experts Group)-2, MPEG-4 or H264. The decoding IC 34 also outputs the information included in the header of the contents data altogether.

The video signal processing IC 35 performs various signal processes relating to the stereoscopic video display. The video signal processing IC 35 processes the video signals to display the video data from the decoding IC 34 as a stereoscopic video. In a specific embodiment, the video signal processing IC 35 detects the left and right frame images FL, FR from the video data decoded by the decoding IC 34. The detected left and right frame images FL, FR are alternately displayed on the display panel 31. Alternatively, the left and right frame images FL, FR may be automatically generated from the video data output from the decoding IC 34. The video signal processing IC 35 alternately outputs the generated left and right frame images FL, FR to the display panel 31. After performing the signal processes relating to the stereoscopic video display, the video signal processing IC 35 generates output signals, which conform to signal input methods of the display panel 31.

It should be noted that the video signal processing IC 35 may execute other processes than the aforementioned processes. For example, the video signal processing IC 35 may perform adjustment processes for colors of the displayed video or interpolation of images between the frames of the video data generated by the decoding IC 34 to increase a frame rate of the video according to characteristics of the display panel 31.

The video signal processing IC 35 may output information such as the frame rate of the video and the display time period per frame image FL or FR displayed on the display panel 31 to the transmission control IC 36 on the basis of the information included in the header of the contents data related to the frame rate and the display time period per frame image as well as the interpolation processes on the video data performed by the video signal processing IC 35.

The transmission control IC 36 generates synchronization signals in synchronism with the left and right frame images FL, FR generated by the video signal processing IC 35. The transmission control IC 36 then outputs the generated synchronization signals to the transmission device 33.

The transmission control IC 36 may output a signal for notifying the illumination controller integrated in the illuminator 2A of other information output from the video signal processing IC 35 (e.g., information such as the frame rate of the stereoscopic video displayed on the display panel 31 and the display time period per frame image FL or FR displayed on the display panel 31).

The CPU 37 controls various elements (e.g., the decoding IC 34 and the video signal processing IC 35) of the display device 3A, for example, according to programs recorded in the memory 38 and external inputs (not shown). As a result, the CPU 37 conducts control of the whole display device 3A.

The memory 38 is used as a region for recording the programs which is executed by the CPU 37, and temporary data generated during the program execution. A volatile RAM (Random Access Memory) or non-volatile ROM (Read Only Memory) may be used as the memory 38.

The clock 39 supplies clock signals to the CPU 37 and other components so that the clock signals serve as operation references of various ICs.

The video signals (left and right frame images FL, FR) output from the video signal processing IC 35 are displayed on the display panel 31. A viewer wearing the eyeglass device 4A stereoscopically perceives the frame images displayed on the display panel 31 under the stereoscopic vision assistance of the eyeglass device 4A.

The transmission device 33 outputs synchronization signals to the illumination controller integrated in the illuminator 2A and the eyeglass device 4A under control of the transmission control IC 36. The light source 21 of the illuminator 2A blinks in response to the synchronization signals as described in the context of FIG. 2. The eyeglass device 4A generates timing signals in response to the synchronization signals to make the optical filter portion execute the stereoscopic vision assistance in response to the generated timing signals as described in the context of FIG. 2.

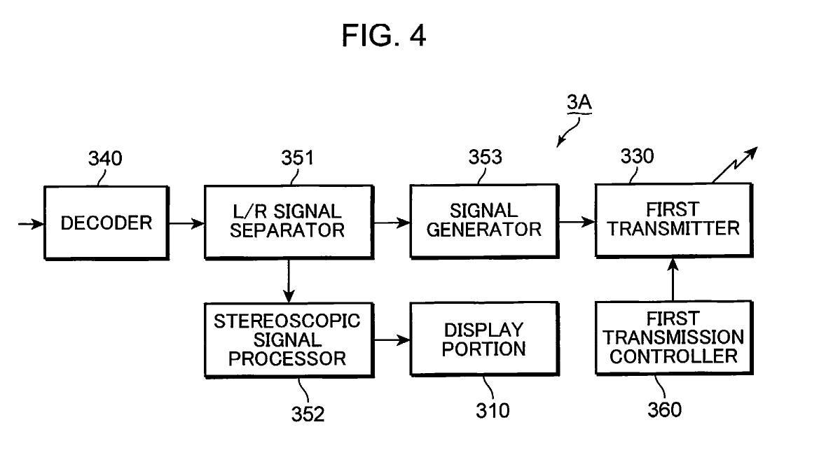

FIG. 4 is a block diagram schematically showing the functional configuration of the display device 3A. The display device 3A is further described with reference to FIGS. 1 to 4.

The display device 3A includes a decoder 340, an L/R signal separator 351, a stereoscopic signal processor 352, the display portion 310, a signal generator 353, a first transmission controller 360, and a first tramsmitter 330.

The decoder 340 corresponding to the decoding IC 34 described in the context of FIG. 3 receives the encoded video signals. The decoder 340 decodes the input video signals to output the decoded video signals to the L/R signal separator 351. The decoder 340 also outputs the information such as the frame rate and the display time period per frame image FL or FR included in the header of the played contents data to the signal generator 353 via the L/R signal separator 351.

The L/R signal separator 351 generates or separates video signals for the left and right eyes (video signals used for displays of the left and right frame images FL, FR) from the video signals decoded by the decoder 340.

The stereoscopic signal processor 352 adjusts the video signals for the left and right eyes separated by the L/R signal separator 351 according to characteristics of the display portion 310 to display the video to be viewed through the eyeglass device 4A. For example, the stereoscopic signal processor 352 executes processes to adjust a parallax amount between the left and right frame images FL, FR according to a display screen size of the display portion 310. It should be noted that the display portion 310 corresponds to the display panel 31 shown in FIG. 1.

The signal generator 353 generates synchronization signals in synchronism with or in response to the left and right frame images FL, FR generated by the L/R signal separator 351. Meanwhile, types (e.g., waveform) and generation timings of the synchronization signals may be adjusted according to characteristics of the display portion 310. The signal generator 353 may further generate a first signal for transmitting information on the display time period per frame image FL or FR, which is included in the header of the played contents data, and/or, which is determined by characteristics of the display portion 310 and/or by video signal processes performed by the L/R signal separator 351, to the illumination controller integrated in the illuminator 2A. Alternatively, the signal generator 353 may further generate a second signal for transmitting information on the frame rate, which is included in the header of the reproduced contents data, and/or, which is determined by characteristics of the display portion 310 and/or the video signal processes performed by the L/R signal separator 351, to the illumination controller integrated in the illuminator 2A. The first and/or second signals are preferably different in waveform from the synchronization signal.

The L/R signal separator 351 and the stereoscopic signal processor 352 correspond to the video signal processing IC 35 in the hardware configuration described in the context of FIG. 3. The signal generator 353 corresponds to the video signal processing IC 35 and/or the transmission control IC 36 in the hardware configuration described in the context of FIG. 3.

The display portion 310 displays the video signals processed by the stereoscopic signal processor 352 as a video. As described above, in the hardware configuration described in the context of FIG. 3, the display portion 310 corresponds to the display panel 31.

The first tramsmitter 330 sends the synchronization signals generated by the signal generator 353 to the eyeglass device 4A under control of the first transmission controller 360. The first tramsmitter 330 corresponds to the transmission device 33 in the hardware configuration described in the context of FIG. 3.

The first transmission controller 360 controls a data volume and a transmission interval of the synchronization signals to be sent. The first transmission controller 360 corresponds to the transmission control IC 36 in the hardware configuration described in the context of FIG. 3.

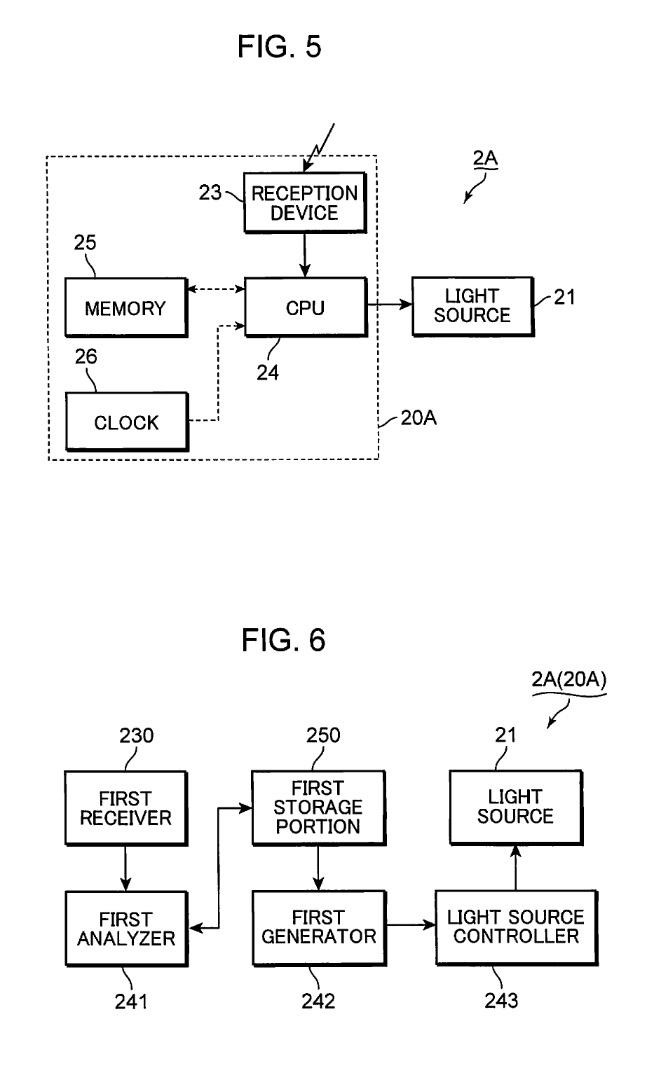

FIG. 5 is a block diagram schematically showing a hardware configuration of the illuminator 2A and the illumination controller integrated in the illuminator 2A. The illuminator 2A and the illumination controller integrated in the illuminator 2A are described with reference to FIGS. 1 to 3 and FIG. 5.

The illuminator 2A includes the light source 21 and the illumination controller 20A as described above. The illumination controller 20A includes a CPU 24, a memory 25, a clock 26 and the reception device 23.

The CPU 24 controls the whole illuminator 2A, for example, according to programs recorded in the memory 25, the synchronization signals, the first and second signals and the luminance signals including information on a luminance of the display panel 31, which are transmitted from the transmission device 33 of the display device 3A, and signals which are transmitted from any external devices such as a remote controller. In the following detailed specific embodiments, the CPU 24 controls the illuminator 2A according to the signals from the eyeglass device 4A and the remote controller.

The memory 25 is used as a region for recording data from program execution by the CPU 24 and holding temporary data for the program execution. The memory 25 may further store information included in the synchronization signals, the first and second signals, which are transmitted from the transmission device 33 of the display device 3A.

The clock 26 supplies clock signals to the CPU 24 of the illuminator 2A and other elements so that the clock signals serve as operational references. The clock signals may be frequency-divided or frequency-multiplied as appropriate.

The reception device 23 receives the synchronization signals, the first and second signals and the luminance signals from the transmission device 33 of the display device 3A as described above. In the following detailed specific embodiments, the reception device 23 receives signals from the eyeglass device 4A.

The light source 21 illuminates a space R where the display device 3A is placed. The light source 21 repeats blinking in synchronism with switching and display operations of the frame images FL, FR of the stereoscopic video displayed on the display panel 31 under control of the CPU 24 as described in the context of FIG. 2. As a result, the light source 21 creates a dark environment in the space R while the frame image FL or FR displayed on the display panel 31 are viewed and a bright environment in the space R while there is the switching operation between the left and right frame images FL, FR. Thus, a viewer is provided with an environment suitable for viewing stereoscopic video. Other users who do not view the stereoscopic video are simultaneously provided with an environment bright enough to do other behaviors than viewing the stereoscopic video. As described above, for example, an LED is preferably used as the light source 21.

FIG. 6 is a block diagram schematically showing a functional configuration of the illuminator 2A. The illuminator 2A is further described with reference to FIGS. 1 and 2 and FIGS. 4 to 6.

The illuminator 2A includes a first receiver 230, a first analyzer 241, a first storage portion 250, a first generator 242 and a light source controller 243, in addition to the light source 21.

The first receiver 230 receives the synchronization signals and the first and second signals from the first tramsmitter 330 of the display device 3A as described above. In the hardware configuration shown in FIG. 5, the first receiver 230 corresponds to the reception device 23.

The first analyzer 241 analyzes information included in the synchronization signals and the first and second signals which are received by the first receiver 230. For example, the first analyzer 241 may identify whether the signal received by the first receiver 230 is the synchronization signal, the first signal or the second signal, on the basis of a signal waveform received by the first receiver 230. The first analyzer 241 may identify, for example, from the waveform of the synchronization signal, whether the synchronization signal indicates a display start or display end of the frame image FL or FR displayed on the display portion 310. The first analyzer 241 may further extract and/or analyze information included in the first signal (i.e., the information on the display time period per frame image FL or FR displayed on the display portion 310), for example, from the waveform of the first signal. Alternatively and/or additionally, the first analyzer 241 may extract and/or analyze information included in the second signal (i.e., the information on the frame rate of the stereoscopic video displayed on the display portion 310), for example, from the waveform of the second signal. In the following detailed other specific embodiments, the first analyzer 241 analyzes the timing to decrease a light amount, which passes through the left or right filter 41, 42, on the basis of signals, which is transmitted from the eyeglass device 4A. In the following detailed other specific embodiments, the first analyzer 241 analyzes the timing of the non-display period on the basis of luminance variation of the display portion 310. The information obtained by the first analyzer 241 from the synchronization signal, the first and/or second signals, the luminance of the display portion 310, the signal from the eyeglass device 4A is used as the timing information on timings of switching and/or display operations of the frame images of the stereoscopic video displayed by the display portion 310 of the display device 3A. In the following detailed specific embodiments, a remote controller sends a signal which indicates a viewer's request for a degree of brightness/darkness in the space R. The first analyzer 241 may use the signal from the remote controller as the timing information.

The first analyzer 241 corresponds to a part of programs executed by the CPU 24 in the hardware configuration shown in FIG. 5.

The first storage portion 250 records/holds the timing information acquired by the first analyzer 241 in response to the synchronization signals, the first and second signals and the aforementioned other various signals. In the hardware configuration shown in FIG. 5, the first storage portion 250 corresponds to the memory 25. The CPU 24 records the timing information in the memory 25.

The first generator 242 generates on-signals and off-signals for blinking the light source 21 on the basis of the timing information analyzed by the first analyzer 241. For example, as described in the context of FIG. 2, the first generator 242 generates an on-signal for brightening the light source 21 in synchronism with a display end of the left frame image FL. The first generator 242 generates an off-signal for darkening the light source 21 in synchronism with a display start of the right frame image FR. Similarly, the first generator 242 generates an on-signal for brightening the light source 21 in synchronism with the display end of the right frame image FR. The first generator 242 generates an off-signal for darkening the light source 21 in synchronism with the display start of the left frame image FL. The first generator 242 corresponds to the CPU 24 and the clock 26 in the hardware configuration shown in FIG. 5.

The light source controller 243 blinks the light source 21 in response to the on-signals and the off-signals generated by the first generator 242 as described above. The light source controller 243 corresponds to programs for light source control to be executed by the CPU 24 in the hardware configuration shown in FIG. 5.

The light source 21 illuminates the space R, in which the display device 3A is placed, with blinking under the control of the light source controller 243. The light source 21 repeatedly blinks in synchronism with switching and display operations of the frame images FL, FR of the video displayed on the display panel 31 under the control of the light source controller 243 as described in the context of FIG. 2. In the present embodiment, the first analyzer 241, the first storage portion 250, the first generator 242 and the light source controller 243 are used as the control portions configured to blink the light source 21 on the basis of the timing information transmitted by the synchronization signals, the first and/or second signals.

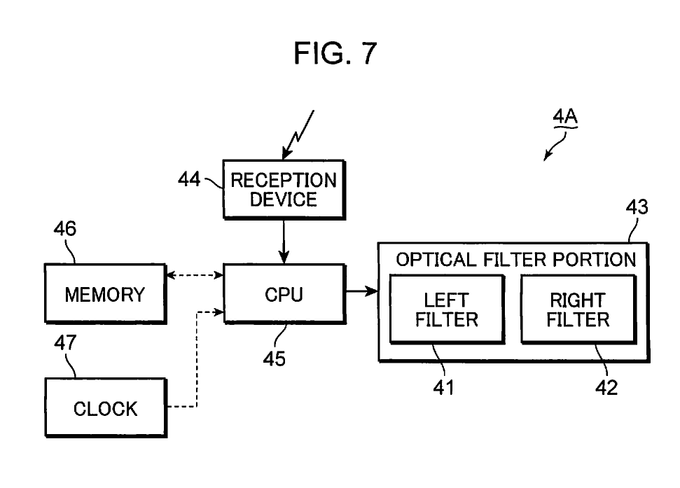

FIG. 7 is a block diagram schematically showing a hardware configuration of the eyeglass device 4A. The eyeglass device 4A is described with reference to FIGS. 1 to 3 and FIG. 7.

The eyeglass device 4A includes a CPU 45, a memory 46 and a clock 47, in addition to the reception device 44 and the optical filter portion 43.

The CPU 45 controls the whole eyeglass device 4A, for example, according to programs recorded in the memory 46 and the synchronization signals transmitted from the transmission device 33 of the display device 3A.

The memory 46 is used as a region for recording data of the programs executed by the CPU 45 and holding temporary data during the program execution.

The clock 47 supplies clock signals to the CPU 45 of the eyeglass device 4A and other elements so that the clock signals serve as operation references. The clock signal may be divided or multiplied in frequency as appropriate.

The reception device 44 receives the synchronization signals and the first and second signals which are transmitted from the transmission device 33 of the display device 3A.

The optical filter portion 43 includes the left filter 41 situated in front of the left eye and the right filter 42 situated in front of the right eye of a viewer wearing the eyeglass device 4A as described above. The left and right filters 41, 42 of the optical filter portion 43 perform the stereoscopic vision assistance described in the context of FIG. 2 under the control of the CPU 45. While the display device 3A displays the left frame image FL, the left filter 41 increases the light amount transmitted to the viewer's left eye whereas the right filter 42 decreases the light amount transmitted to the viewer's right eye. While the display device 3A displays the right frame image FR, the right filter 42 increases the light amount transmitted to the viewer's right eye whereas the left filter 41 decreases the light amount transmitted to the viewer's left eye. During the switching operation between the left and right frame images FL, FR (i.e., while the display panel 31 of the display device 3A does not display the frame images FL, FR), the left and right filters 41 42 both decrease the light amount transmitted to the viewer's eyes, which allows the viewer to stereoscopically perceive the stereoscopic video displayed on the display panel 31 of the display device 3A.

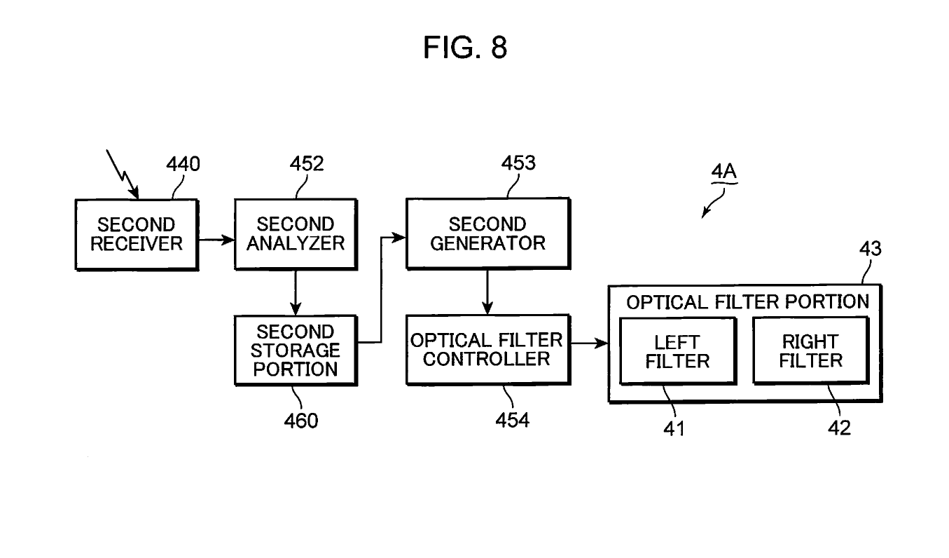

FIG. 8 is a block diagram schematically showing a functional configuration of the eyeglass device 4A. The eyeglass device 4A is further described with reference to FIGS. 1, 2, 4, 7 and 8.

The eyeglass device 4A includes a second receiver 440, a second analyzer 452, a second storage portion 460, a second generator 453 and an optical filter controller 454, in addition to the optical filter portion 43.

The second receiver 440 receives a signal from the display device 3A, and then outputs it to the second analyzer 452. In the hardware configuration shown in FIG. 7, the second receiver 440 corresponds to the reception device 44.

The second analyzer 452 analyzes the information included in the synchronization signals, the first and second signals which are received by the second receiver 440. For example, the second analyzer 452 may identify whether the signal received by the second receiver 440 is the synchronization signal, the first or second signal on the basis of a signal waveform received by the second receiver 440. The second analyzer 452 may further identify whether the synchronization signal indicates a display start or display end of the frame image displayed on the display portion 310, for example, from the waveform of the synchronization signal. The second analyzer 452 may further extract and/or analyze information included in the first signal (i.e., the information on the display time period per frame image FL or FR displayed on the display portion 310), for example, from the waveform of the first signal. Alternatively and/or additionally, the second analyzer 452 may extract and/or analyze information included in the second signal (i.e., the information on the frame rate of the stereoscopic video displayed on the display portion 310), for example, from the waveform of the second signal. The information obtained from the synchronization signal, the first and/or second signals by the second analyzer 452 is used as control information for causing the optical filter portion 43 to perform the stereoscopic vision assistance described in the context of FIG. 2.

The second analyzer 452 corresponds to a part of programs to be executed by the CPU 45 in the hardware configuration shown in FIG. 7.

The second storage portion 460 records/holds the control information, which is analyzed by the second analyzer 452 on the basis of the synchronization signal. In the hardware configuration shown in FIG. 7, the second storage portion 460 corresponds to the memory 46. The CPU 45 records the control information in the memory 46.

The second generator 453 generates timing signals on the basis of the synchronization information analyzed by the second analyzer 452. The second generator 453 corresponds to the CPU 45 and the clock 47 in the hardware configuration shown in FIG. 7.

The optical filter controller 454 performs operational control of the left and right filters 41, 42 of the eyeglass device 4A (control for allowing execution of the stereoscopic vision assistance described in the context of FIG. 2). The optical filter controller 454 corresponds to programs for optical filter control to be executed by the CPU 45 in the hardware configuration shown in FIG. 7.

The optical filter portion 43 executes the stereoscopic vision assistance under the control of the optical filter controller 454 as described above to allow a viewer to stereoscopically perceive the stereoscopic video displayed by the display device 3A.

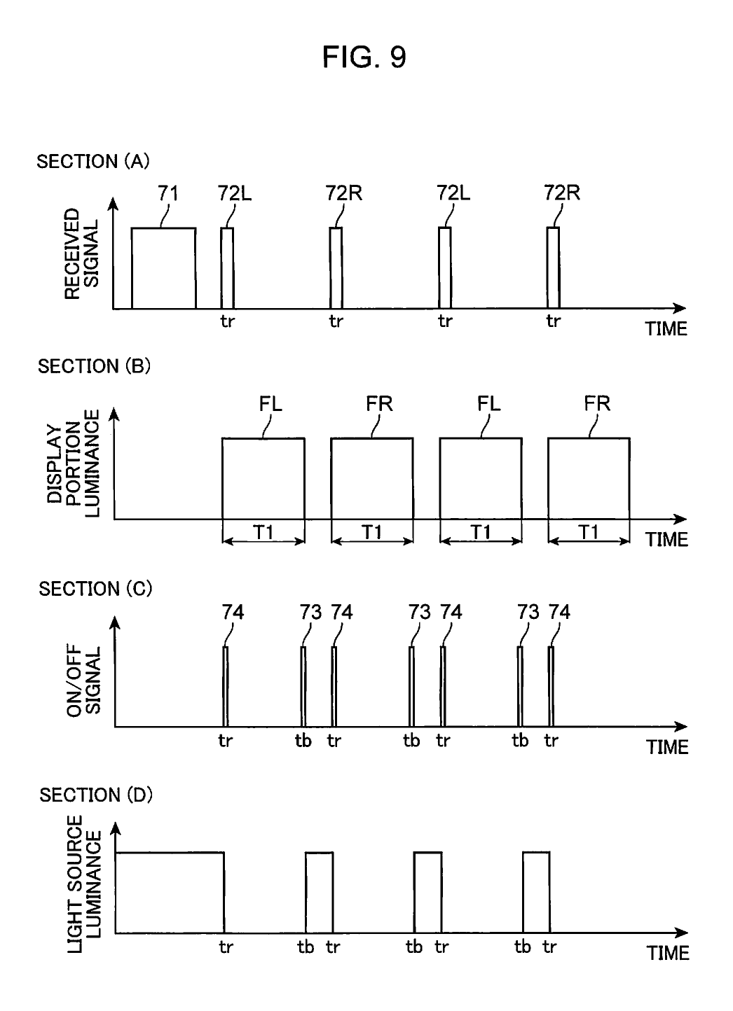

FIG. 9 is a timing chart schematically showing blinking control on the light source 21, which is performed by the illumination controller 20A. The section (A) of FIG. 9 shows signals received by the first receiver 230. The section (B) of FIG. 9 shows a luminance of the display portion 310. The section (C) of FIG. 9 shows on/off-signals generated by the first generator 242. The section (D) of FIG. 9 shows a luminance of the light source 21. The blinking control on the light source 21 is described with reference to FIGS. 1, 2, 4, 6 and 9.

In the present embodiment, the signal generator 353 of the display device 3A generates a first signal 71, a first synchronization signal 72L in synchronism with the display start of the left frame image FL and a first synchronization signal 72R in synchronism with the display start of the right frame image FR. As described above, the first signal 71 includes the first information on the display time period T1 per frame image FL or FR. The first signal 71, the first synchronization signal 72L in synchronism with the display start of the left frame image FL and the first synchronization signal 72R in synchronism with the display start of the right frame image FR preferably have different waveforms from each other. The first tramsmitter 330 transmits the first signal 71 and the first synchronization signals 72L and 72R under the control the first transmission controller 360.

The first receiver 230 of the illumination controller 20A receives the first signal 71, the first synchronization signal 72L in synchronism with the display start of the left frame image FL, and the first synchronization signal 72R in synchronism with the display start of the right frame image FR. The first analyzer 241 extracts the information on the display time period T1 per frame image FL or FR from the first signal 71, and then measures the reception times tr of the first synchronization signals 72L, 72R.

The first analyzer 241 adds a display time period T1 to the reception time tr, and calculates a time tb at which the on-signal 73 for brightening the light source 21 is generated. The first analyzer 241 defines a time period from the reception time tr of the first synchronization signal 72L or 72R to the calculated time tb immediately after the reception time tr (i.e., the time period from when the first synchronization signal 72L or 72R is received by the first receiver 230 to when the display time period T1 per frame image FL or FR passes) as a first period, during which the light source 21 is darkened. The time period from the calculated time tb to the reception time tr of the first synchronization signal 72L or 72R immediately after the calculated time tb (i.e., the period from the reception time tr of the previously received first synchronization signal 72L or 72R to the reception of the next first synchronization signal 72L or 72R after the display time period T1 per frame image FL or FR passes) is defined as a second period, during which the light source 21 is brightened. Thus, the first analyzer 241 determines the first period for darkening the light source 21 and the second period for brightening the light source 21 on the basis of the first synchronization signals 72L, 72R and the first signal 71.

The first generator 242 of the illumination controller 20A generates an off-signal 74 for darkening the light source 21 at the time tr at which the first synchronization signal 72L or 72R is received. The first generator 242 generates an on-signal 73 for brightening the light source 21 at the time tb calculated by the first analyzer 241.

The light source controller 243 controls the light source 21 in response to the on-signals 73 and the off-signals 74 which are generated by the first generator 242. The light source 21 is darkened during the first period and brightened during the second period according to the determination by the first analyzer 241.

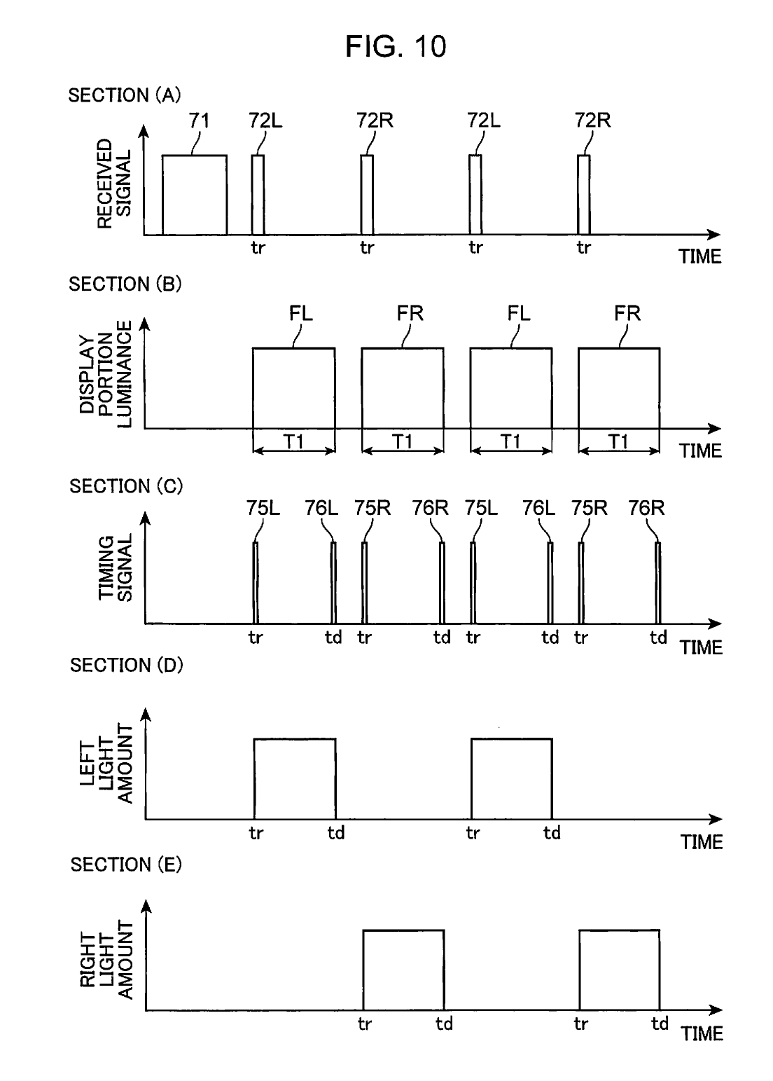

FIG. 10 is a schematic view showing a control for the stereoscopic vision assistance of the optical filter portion 43. The section (A) of FIG. 10 shows signals received by the second receiver 440. The section (B) of FIG. 10 shows a luminance of the display portion 310. The section (C) of FIG. 10 shows timing signals, which are generated by the second generator 453 to make the optical filter portion 43 execute the stereoscopic vision assistance. The section (D) of FIG. 10 shows variation in light amount, which passes through the left filter 41 and reaches the viewer's left eye. The section (E) of FIG. 10 shows variation in light amount which passes through the right filter 42 and reaches the viewer's right eye. The control for the stereoscopic vision assistance of the optical filter portion 43 is described with reference to FIGS. 1, 2, 4, 8 to 10.

As described in the context of FIG. 9, the signal generator 353 of the display device 3A generates the first signal 71, the first synchronization signal 72L in synchronism with the display start of the left frame image FL and the first synchronization signal 72R in synchronism with the display start of the right frame image FR. As described above, the first signal 71 includes the information on the display time period T1 per frame image FL or FR. The first tramsmitter 330 transmits the first signal 71 and the first synchronization signals 72L and 72R under the control of the first transmission controller 360.

The second receiver 440 of the eyeglass device 4A receives the first signal 71, the first synchronization signal 72L in synchronism with the display start of the left frame image FL and the first synchronization signal 72R in synchronism with the display start of the right frame image FR. The second analyzer 452 extracts the information on the display time period T1 per frame image FL or FR from the first signal 71. The second analyzer 452 measures the reception time tr of the first synchronization signal 72L or 72R.

The second analyzer 452 adds the display time period T1 to the reception time tr, and calculates the time td at which the light amount passing through the left or right filter 41, 42 is decreased. The time td may be substantially the same time as the time tb described in the context of FIG. 9. The second analyzer 452 determines the reception time tr of the first synchronization signal 72L or 72R as the time at which the light amount passing through the left or right filter 41, 42 is increased. In the second storage portion 460, the second analyzer 452 records the reception times tr of the first synchronization signals 72L, 72R in synchronism with the display starts of the left and right frame images FL, FR, and the time td, at which the light amount passing through the left or right filter 41, 42 is decreased.

The second generator 453 generates a timing signal 75L for increasing the light amount passing through the left filter 41 at the reception time tr of the first synchronization signal 72L. At the time td immediately after the reception time tr of the first synchronization signal 72L, a timing signal 76L for decreasing the light amount passing through the left filter 41 is generated. Similarly, the second generator 453 generates a timing signal 75R for increasing the light amount passing through the right filter 42 at the reception time tr of the first synchronization signal 72R. At the time td immediately after the reception time tr of the first synchronization signal 72R, a timing signal 76R for decreasing the light amount passing through the right filter 42 is generated.

The optical filter controller 454 controls the optical filter portion 43 in response to the timing signals 75L, 76L, 75R and 76R generated by the second generator 453. The left filter 41 increases the light amount transmitted to the left eye in response to the timing signal 75L, and decreases the light amount transmitted to the left eye in response to the timing signal 76L. Similarly, the right filter 42 increases the light amount transmitted to the right eye in response to the timing signal 75R, and decreases the light amount transmitted to the right eye in response to the timing signal 76R.

A series of the operations described in the context of FIGS. 9 and 10 works to achieve the display and switching operation of the frame images FL, FR in the display panel 31 and the synchronization between the light source 21 and the optical filter portion 43, as described in the context of FIG. 2.

### Second Embodiment

An illumination system 1A and an eyeglass device 4A in accordance with the second embodiment are described hereinafter. Configurations of the illumination system 1A and the eyeglass device 4A in accordance with the second embodiment are substantially the same as the configurations of the illumination system 1A and the eyeglass device 4A in accordance with the first embodiment. The configurations and operations of the illumination system 1A and the eyeglass device 4A described in the context of FIGS. 1 to 10 are also substantially common in the second embodiment. Differences from the illumination system 1A and the eyeglass device 4A in accordance with the first embodiment are mainly shown hereinafter as descriptions of the illumination system 1A and the eyeglass device 4A in accordance with the second embodiment.

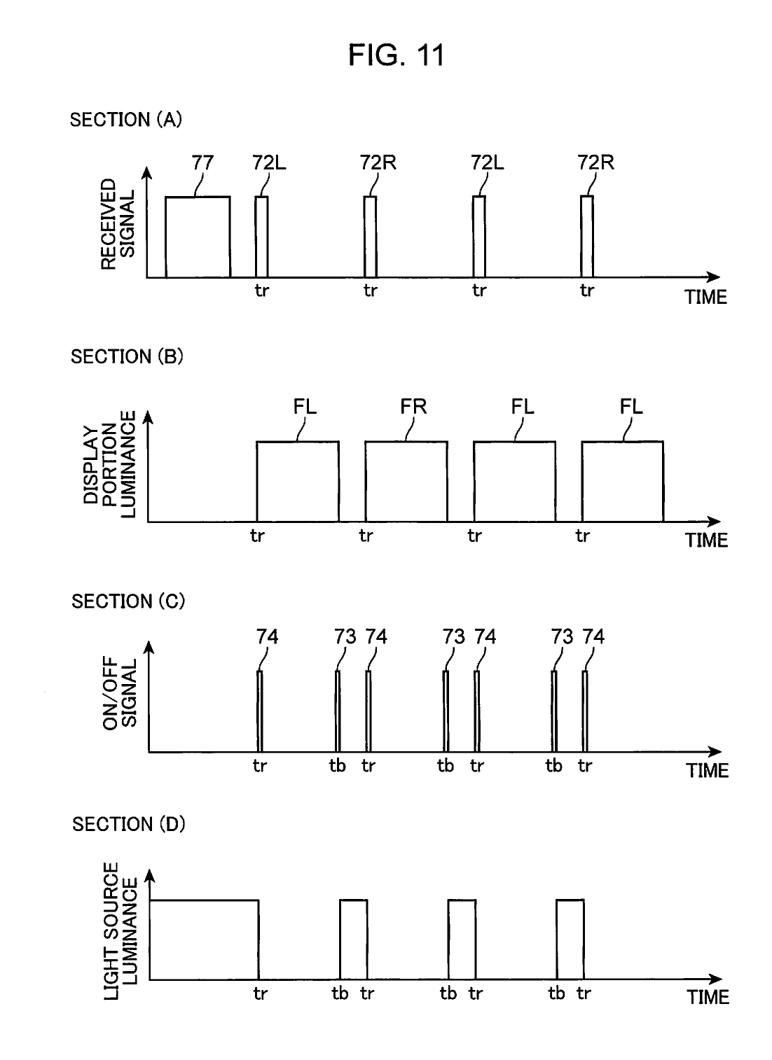

FIG. 11 is a timing chart schematically showing a blinking control on the light source 21 performed by the illumination controller 20A in accordance with the second embodiment. The section (A) of FIG. 11 shows signals received by the first receiver 230. The section (B) of FIG. 11 shows a luminance of the display portion 310. The section (C) of FIG. 11 shows on/off-signals generated by the first generator 242. The section (D) of FIG. 11 shows a luminance of the light source 21. The blinking control on the light source 21 is described with reference to FIGS. 1, 2, 4, 6 and 11.

In the present embodiment, the signal generator 353 of the display device 3A generates a second signal 77, a first synchronization signal 72L in synchronism with the display start of the left frame image FL, and a first synchronization signal 72R in synchronism with the display start of the right frame image FR. As described above, the second signal 77 includes the second information on the frame rate of the stereoscopic video displayed by the display portion 310. The second signal 77, the first synchronization signal 72L in synchronism with the display start of the left frame image FL and the first synchronization signal 72R in synchronism with the display start of the right frame image FR preferably have different waveforms from each other. The first tramsmitter 330 transmits the second signal 77 and the first synchronization signals 72L, 72R under the control of the first transmission controller 360.

The first receiver 230 of the illumination controller 20A receives the second signal 77, the first synchronization signal 72L in synchronism with the display start of the left frame image FL and the first synchronization signal 72R in synchronism with the display start of the right frame image FR. The first analyzer 241 extracts information on the frame rate from the second signal 77. The first analyzer 241 measures the reception time tr of the first synchronization signal 72L or 72R.

The second analyzer 452 calculates a time period T0 defined as an inverse of the frame rate. Using a constant C (C>1) stored in advance in the first storage portion 250, for example, the time tb defined by the following equation 1 is calculated.

$$tb = tr + ( 1 - \frac{1}{C} ) T 0 \qquad [ Equation 1 ]$$

The first analyzer 241 defines a time period from the reception time tr of the first synchronization signal 72L or 72R to the calculated time tb immediately after the reception time tr as the first period, during which the light source 21 is darkened. The time period from the calculated time tb to the reception time tr of the first synchronization signal 72L or 72R immediately after the calculated time tb is defined as the second period, during which the light source 21 is brightened. Thus, the first analyzer 241 determines the first period for darkening the light source 21 and the second period for brightening the light source 21 on the basis of the first synchronization signals 72L and 72R and the second information of the second signal 77.

The first generator 242 of the illumination controller 20A generates an off-signal 74 for darkening the light source 21 at the time tr at which the first synchronization signal 72L or 72R is received. The first generator 242 further generates an on-signal 73 for brightening the light source 21 at the time tb calculated by the first analyzer 241.

The light source controller 243 controls the light source 21 in response to the on-signals 73 and the off-signals 74 generated by the first generator 242. The light source 21 is darkened during the first period and brightened during the second period according to the determination by the first analyzer 241.

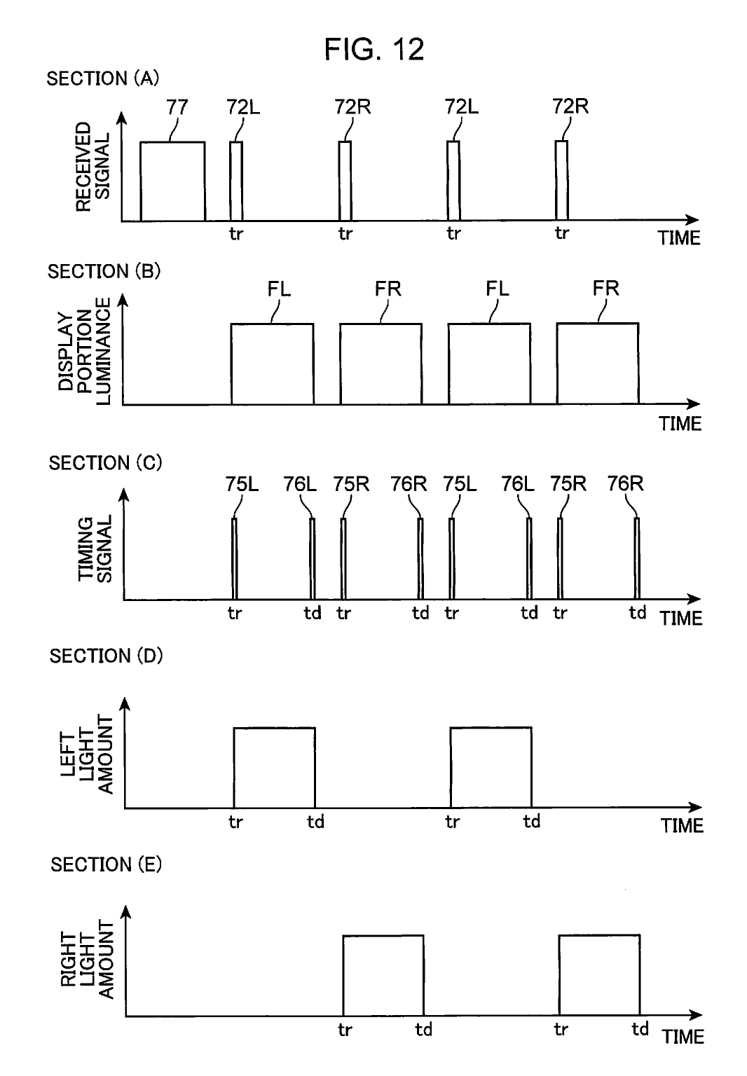

FIG. 12 is a timing chart schematically showing a control for the stereoscopic vision assistance of the optical filter portion 43. The section (A) of FIG. 12 shows signals received by the second receiver 440. The section (B) of FIG. 12 shows a luminance of the display portion 310. The section (C) of FIG. 12 shows timing signals, which are generated by the second generator 453 to make the optical filter portion 43 perform the stereoscopic vision assistance. The section (D) of FIG. 12 shows variation in light amount, which passes through the left filter 41 and reaches the viewer's left eye. The section (E) of FIG. 12 shows variation in light amount which passes through the right filter 42 and reaches the viewer's right eye. The control for the stereoscopic vision assistance of the optical filter portion 43 is described with reference to FIGS. 1, 2, 4, 8, 11 and 12.

As described in the context of FIG. 11, the signal generator 353 of the display device 3A generates the second signal 77, the first synchronization signal 72L in synchronism with the display start of the left frame image FL and the first synchronization signal 72R in synchronism with the display start of the right frame image FR. As described above, the second signal 77 includes the information on the frame rate of the stereoscopic video displayed by the display portion 310. The first tramsmitter 330 transmits the second signal 77 and the first synchronization signals 72L, 72R under the control of the first transmission controller 360.

The second receiver 440 of the eyeglass device 4A receives the second signal 77, the first synchronization signal 72L in synchronism with the display start of the left frame image FL and the first synchronization signal 72R in synchronism with the display start of the right frame image FR. The second analyzer 452 extracts the information on the frame rate of the stereoscopic video displayed by the display portion 310 from the second signal 77. The second analyzer 452 then measures the reception time tr of the first synchronization signal 72L or 72R.

The second analyzer 452 further calculates the time td, which is substantially the same as the time tb described in the context of FIG. 11 using the equation 1. The second analyzer 452 determines the reception time tr of the first synchronization signal 72L or 72R as the time at which the light amount passing through the left or right filter 41, 42 is increased. In the second storage portion 460, the second analyzer 452 records the reception times tr of the first synchronization signals 72L, 72R in synchronism with the display starts of the left and right frame images FL, FR and the time td, at which the light amount passing through the left or right filter 41, 42 is decreased.

The second generator 453 generates a timing signal 75L for increasing the light amount passing through the left filter 41 at the reception time tr of the first synchronization signal 72L. At the time td immediately after the reception time tr of the first synchronization signal 72L, a timing signal 76L for decreasing the light amount passing through the left filter 41 is generated. Similarly, the second generator 453 generates a timing signal 75R for increasing the light amount passing through the right filter 42 at the reception time tr of the first synchronization signal 72R. At the time td immediately after the reception time tr of the first synchronization signal 72R, a timing signal 76R for decreasing the light amount passing through the right filter 42 is generated.

The optical filter controller 454 controls the optical filter portion 43 in response to the timing signals 75L, 76L, 75R and 76R generated by the second generator 453. The left filter 41 increases the light amount transmitted to the left eye in response to the timing signal 75L, and decreases the light amount transmitted to the left eye in response to the timing signal 76L. Similarly, the right filter 42 increases the light amount transmitted to the right eye in response to the timing signal 75R, and decreases the light amount transmitted to the right eye in response to the timing signal 76R.

A series of the operations described in the context of FIGS. 11 and 12 works to achieve the display and switching operation of the frame images FL, FR in the display panel 31 and the synchronization between the light source 21 and the optical filter portion 43, as described in the context of FIG. 2.

In the first and second embodiments, the extraction of the first and second information from the first and second signals 71, 77 may be performed by means of a lookup table stored in advance in the first storage portion 250 of the illumination controller 20A and the second storage portion 460 of the eyeglass device 4A. Alternatively, by means of pulse widths of the first and signals 71, 77, the first analyzer 241 of the illumination controller 20A and the second analyzer 452 of the eyeglass device 4A may calculate the display time period T1 per frame image FL or FR and the frame rate.

### Third Embodiment

An illumination system 1A and an eyeglass device 4A in accordance with the third embodiment is described hereinafter. Configurations of the illumination system 1A and the eyeglass device 4A in accordance with the third embodiment are substantially the same as the configurations of the illumination system 1A and the eyeglass device 4A in accordance with the first embodiment. The configurations and operations of the illumination system 1A and the eyeglass device 4A described in the context of FIGS. 1 to 10 are also substantially common in the third embodiment. Differences from the illumination system 1A and the eyeglass device 4A in accordance with the first embodiment are shown hereinafter as descriptions of the illumination system 1A and the eyeglass device 4A in accordance with the third embodiment.

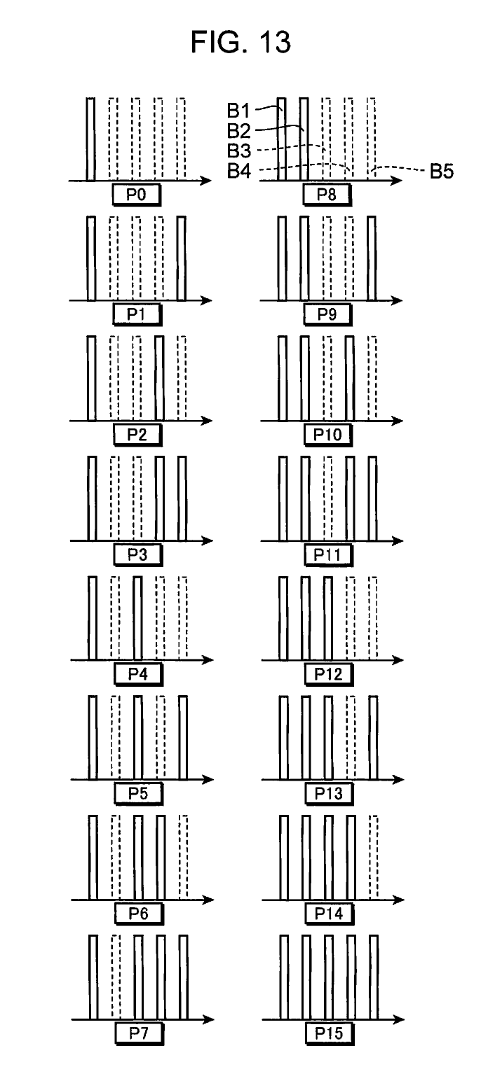

FIG. 13 shows synchronization signals generated by the signal generator 353 of the display device 3A. The synchronization signals generated by the signal generator 353 of the display device 3A are described with reference to FIGS. 4 and 13.

The synchronization signal generated by the signal generator 353 of the display device 3A includes a bit serial having at least one pulse. The term “bit serial” used in the present embodiment means a series of pulses, each of which corresponds to 1-bit data. The bit serials of the synchronization signal shown in FIG. 13 may include five pulses at the maximum. Altanatively, a number of pulses included in the bit serial may be less or more than 5. The waveform depicted with a solid line in FIG. 13 indicates presence of a pulse. The waveform depicted with a dotted line indicates absence of a pulse. The bit serial patterns of the bit serials P0 to P15 shown in FIG. 13 are different from each other. In the present embodiment, the signal generator 353 may generate a synchronization signal with the bit serial of any pattern shown in FIG. 13. If all the pulses are present as shown in the bit serial P15, the period of the pulse waveform (intervals between pulses) is constant. As described in FIG. 13, in the synchronization signal, the pulses B1 situated at the beginning are present all over the bit serials P0 to P15. The pulse B1 serves as a timing pulse for notifying the transmission of the synchronization signal to the illumination controller 20A and/or the eyeglass device 4A.

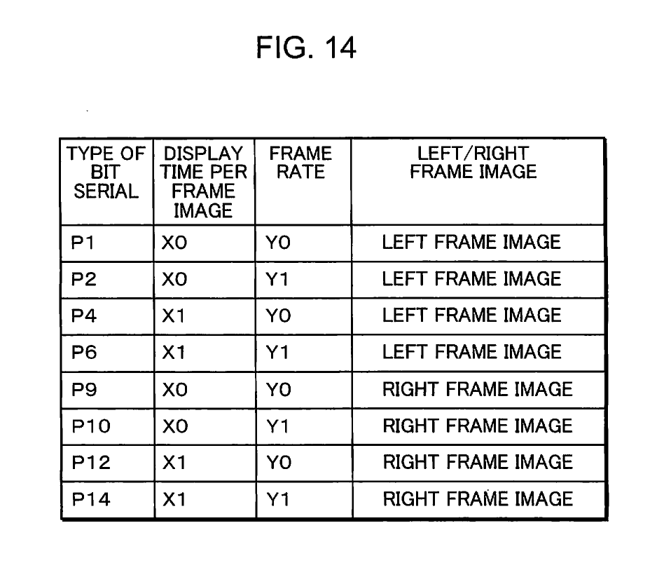

FIG. 14 shows information assigned to the bit serial patterns of the synchronization signals shown in FIG. 13, respectively. The information assigned to each bit serial pattern of the synchronization signal with reference to FIGS. 2, 4, 6, 8, 13 and 14.

In the present embodiment, the information assigned to each bit serial of the synchronization signal is related to the display time period per frame image, the frame rate and the type of the frame image with which the synchronization signal synchronizes. As described above, the first pulse B1 is used as the timing pulse. The second pulse B2 represents a type of the frame image with which the synchronization signal synchronizes. Without the second pulse B2, the second analyzer 452 of the eyeglass device 4A determines that the synchronization signal synchronizes with the left frame image FL. If there is the second pulse B2, the second analyzer 452 of the eyeglass device 4A determines that the synchronization signal synchronizes with the right frame image FR. The third pulse B3 represents information on the display time period per frame image. Without the third pulse B3, the first analyzer 241 of the illumination controller 20A and the second analyzer 452 of the eyeglass device 4A determine that the display time period per frame image is “X0”. If there is the third pulse B3, the first analyzer 241 of the illumination controller 20A and the second analyzer 452 of the eyeglass device 4A determine that the display time period per frame image is “X1”. The fourth pulse B4 represents information on the frame rate. Without the fourth pulse B4, the first analyzer 241 of the illumination controller 20A and the second analyzer 452 of the eyeglass device 4A determine that the frame rate is “Y0”. If there is the fourth pulse B4, the first analyzer 241 of the illumination controller 20A and the second analyzer 452 of the eyeglass device 4A determine that the frame rate is “Y1”.

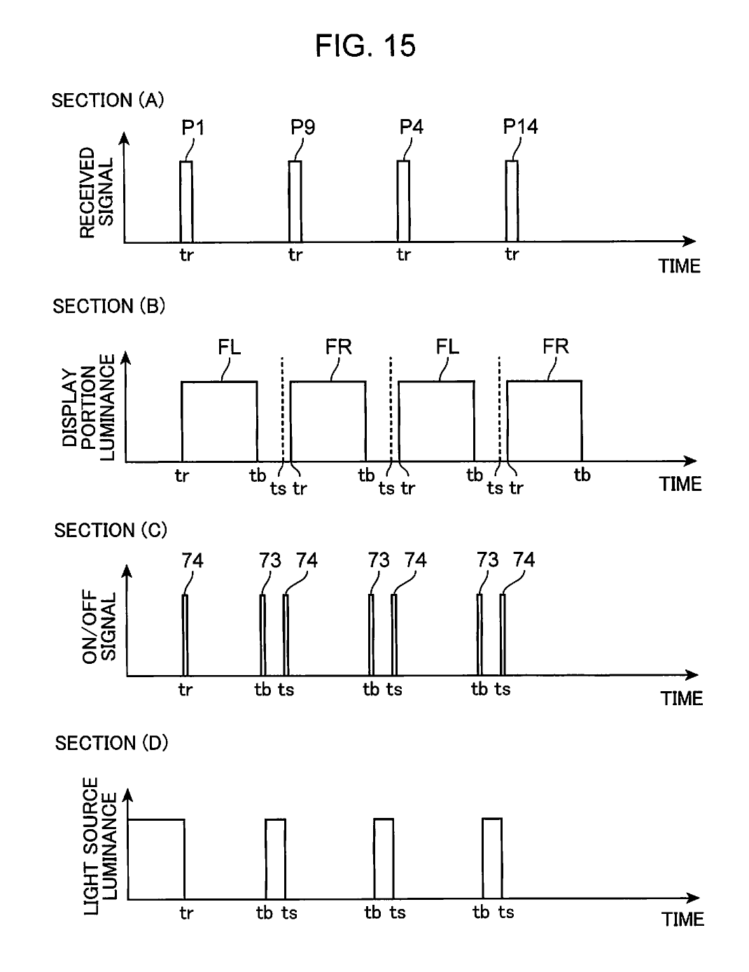

FIG. 15 is a timing chart schematically showing a blinking control on the light source 21 performed by the illumination controller 20A in accordance with the third embodiment. The section (A) of FIG. 15 shows signals received by the first receiver 230. The section (B) of FIG. 15 shows a luminance of the display portion 310. The section (C) of FIG. 15 shows on/off-signals generated by the first generator 242. The section (D) of FIG. 15 shows a luminance of the light source 21. The blinking control on the light source 21 is described with reference to FIGS. 1, 2, 4, 6, 13 to 15.

The first receiver 230 sequentially receives synchronizations signal including the bit serials P1, P9, P4 and P12. As described in the context of FIG. 14, the synchronization signals including the bit serials P1, P4 are received in synchronism with the display start of the left frame image FL, respectively. The synchronization signals including the bit serials P9, P12 are received in synchronism with the display start of the right frame image FR, respectively.

The first analyzer 241 of the illumination controller 20A measures the reception times tr of the synchronization signals including the bit serials P1, P9, P4 and P12, respectively. The first analyzer 241 adds the display time periods per frame image assigned to the bit serials P1, P9, P4 and P14 of the synchronization signals to the corresponding measured reception times tr of them, respectively, and then calculates the times tb at which the on-signal 73 for brightening the light source 21 is generated. The first analyzer 241 further calculates the frame switching times ts on the basis of the measured reception times tr and the information of the frame rates assigned to the bit serials P1, P9, P4 and P14 of the synchronization signals, respectively. The first analyzer 241 determines a time period from the reception time tr of the synchronization signal or the last frame switching time ts to the time tb at which the on-signal 73 for brightening the light source 21 is generated (the time period from when the synchronization signal is received to when the display time period per frame image passes) as the first period, during which the light source 21 is darkened. The first analyzer 241 determines a time period from the time tb, at which the on-signal 73 for brightening the light source 21 is generated, to the immediately subsequent frame switching time ts (alternatively, the immediately subsequent reception time tr of the synchronization signal) (the period from when the frame image display ends to when the next frame image display starts) as the second period, during which the light source 21 is brightened.

The first generator 242 generates the on-signal 73 at the calculated time tb and the off-signal 74 at the reception time tr of the synchronization signal or the calculated time ts. The light source controller 243 controls the light source 21 in response to the on-signal 73 and the off-signal 74, which are generated by the first generator 242. The light source 21 is darkened during the first period and brightened during the second period according to the determination by the first analyzer 241.

In the present embodiment, the synchronization signals including the information on the display time period per frame image and the frame rate are used to transmit the information on the time period from the display end of the frame image FL or FR to the display start of the next frame image FR or FL. Alternatively, the synchronization signal may directly include the information on the time period from the display end of the frame image FL or FR to the display start of the next frame image FR or FL, instead of the information on the frame rate.

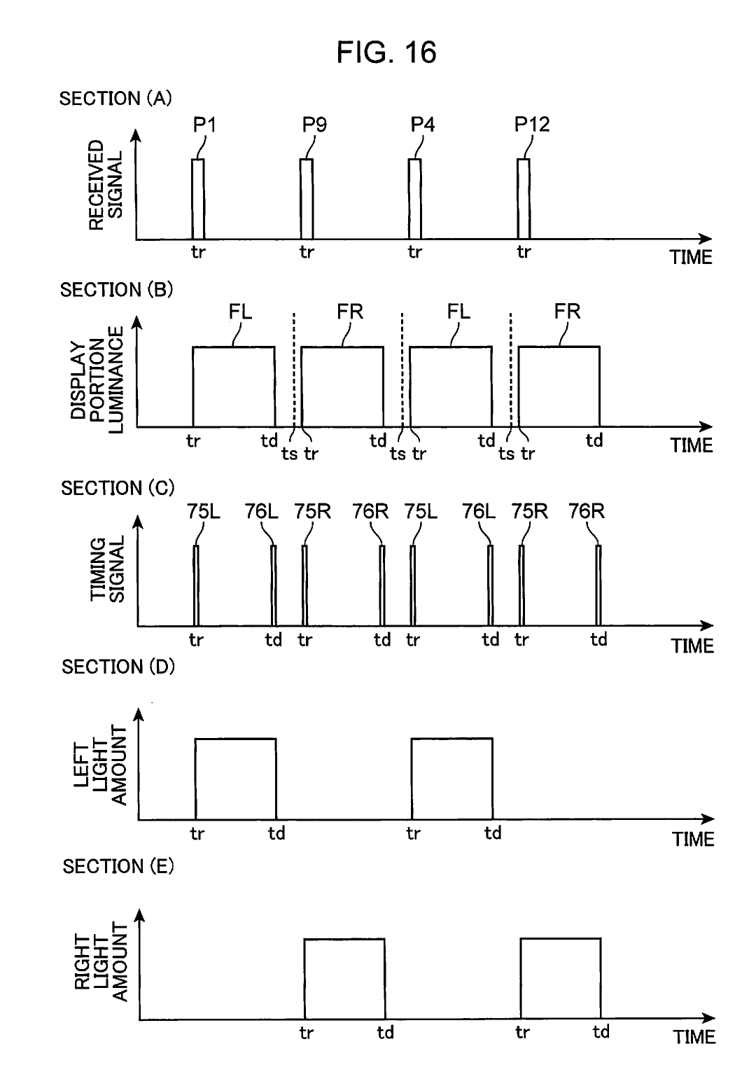

FIG. 16 is a schematic view showing a control for the stereoscopic vision assistance of the optical filter portion 43. The section (A) of FIG. 16 shows signals received by the second receiver 440. The section (B) of FIG. 16 shows a luminance of the display portion 310. The section (C) of FIG. 16 shows timing signals, which are generated by the second generator 453 to make the optical filter portion 43 execute the stereoscopic vision assistance. The section (D) of FIG. 16 shows variation in light amount which passes through the left filter 41 and reaches the viewer's left eye. The section (E) of FIG. 16 shows variation in light amount which passes through the right filter 42 and reaches the viewer's right eye. The control for the stereoscopic vision assistance of the optical filter portion 43 is described with reference to FIGS. 1, 2, 4, 8, 13 to 16.

The second receiver 440 sequentially receives the synchronization signals including the bit serials P1, P9, P4 and P12. As described in the context of FIG. 14, the synchronization signals including the bit serials P1, P4 are received in synchronism with the display start of the left frame image FL, respectively. The synchronization signals including the bit serials P9, P12 are received in synchronism with the display start of the right frame image FR, respectively.

The second analyzer 452 of the eyeglass device 4A measures the reception times tr of the synchronization signals including the bit serials P1, P9, P4 and P12, respectively. The first analyzer 241 adds the display time periods per frame image assigned to the bit serials P1, P9, P4 and P12 of the synchronization signals to the corresponding measured reception times tr, respectively, and calculates the time td at which the timing signal 76L or 76R for decreasing the light amount passing through the left or right filter 41, 42 is generated (the time substantially the same as the time tb).

The second generator 453 generates a timing signal 75L for increasing the light amount passing through the left filter 41 at the reception time tr of the synchronization signal including the bit serial P1 or P4 in synchronism with the display start of the left frame image FL. At the time td immediately after the reception time tr of the synchronization signal including the bit serial P1 or P4, the timing signal 76L is generated to decrease the light amount passing through the left filter 41. Similarly, the second generator 453 generates the timing signal 75R for increasing the light amount passing through the right filter 42 at the reception time tr of the synchronization signal including the bit serial P9 or P12. At the time td immediately after the reception time tr of the synchronization signal including the bit serial P9 or P12, the timing signal 76R is generated to decrease the light amount passing through the right filter 42.

The optical filter controller 454 controls the optical filter portion 43 in response to the timing signals 75L, 76L, 75R and 76R generated by the second generator 453. The left filter 41 increases the light amount transmitted to the left eye in response to the timing signal 75L and decreases the light amount transmitted to the left eye in response to the timing signal 76L. Similarly, the right filter 42 increases the light amount transmitted to the right eye in response to the timing signal 75R and decreases the light amount transmitted to the right eye in response to the timing signal 76R.

A series of the operations described in the context of FIGS. 15 and 16 works to achieve the display and switching operation of the frame images FL, FR in the display panel 31 and the synchronization between the light source 21 and the optical filter portion 43, as described in the context of FIG. 2.

In the present embodiment, the information assigned to the first and second signals 71, 77 used in the first and second embodiments is included in the synchronization signal. As a result, it becomes easier to control the blinking of the light source 21 and the stereoscopic vision assistance of the optical filter portion 43 so that the blinking of the light source 21 and the stereoscopic vision assistance of the optical filter portion 43 are adapted to variation in frame rate of the stereoscopic video displayed by the display device 3A and the display time period of the frame image FL or FR.

### Fourth Embodiment

An illumination system 1A and an eyeglass device 4A in accordance with the fourth embodiment are described hereinafter. Configurations of the illumination system 1A and the eyeglass device 4A in accordance with the fourth embodiment are substantially the same as the configurations of the illumination system 1A and the eyeglass device 4A in accordance with the first embodiment. The configurations and operations of the illumination system 1A and the eyeglass device 4A described in the context of FIGS. 1 to 10 are also substantially common in the fourth embodiment. Differences from the illumination system 1A and the eyeglass device 4A in accordance with the first embodiment are shown hereinafter as descriptions of the illumination system 1A and the eyeglass device 4A in accordance with the fourth embodiment.

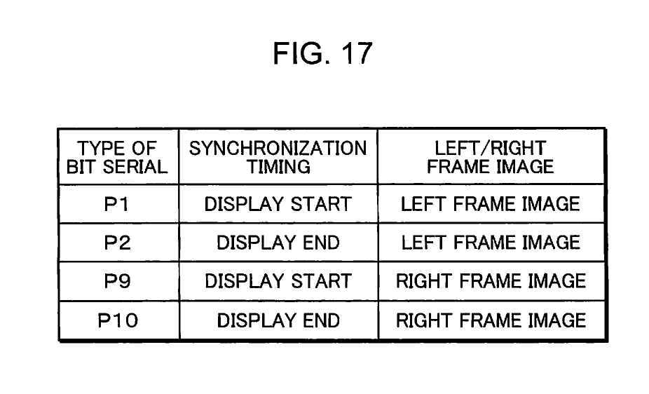

FIG. 17 is a table showing information assigned to bit serial patterns of the synchronization signals shown in FIG. 13, respectively. The information assigned to each bit serial pattern of the synchronization signal is described with reference to FIGS. 2, 4, 6, 8, 13 and 17.

In the present embodiment, the information assigned to each bit serial pattern of the synchronization signal is related to a synchronization timing of the synchronization signal and a type of the frame image with which the synchronization signal synchronizes. As described above, the first pulse B1 is used as the timing pulse. The second pulse B2 represents the type of the frame image with which the synchronization signal synchronizes. Without the second pulse B2, the second analyzer 452 of the eyeglass device 4A determines that the synchronization signal synchronizes with the left frame image FL. If there is the second pulse B2, the second analyzer 452 of the eyeglass device 4A determines that the synchronization signal synchronizes with the right frame image FR. The fourth pulse B4 represents information on the synchronization timing of the synchronization signals. Without the fourth pulse B4, the first analyzer 241 of the illumination controller 20A and the second analyzer 452 of the eyeglass device 4A determine that the synchronization signal synchronizes with the display start of the frame image. If there is the fourth pulse B4, the first analyzer 241 of the illumination controller 20A and the second analyzer 452 of the eyeglass device 4A determine that the synchronization signal synchronizes with the display end of the frame image.

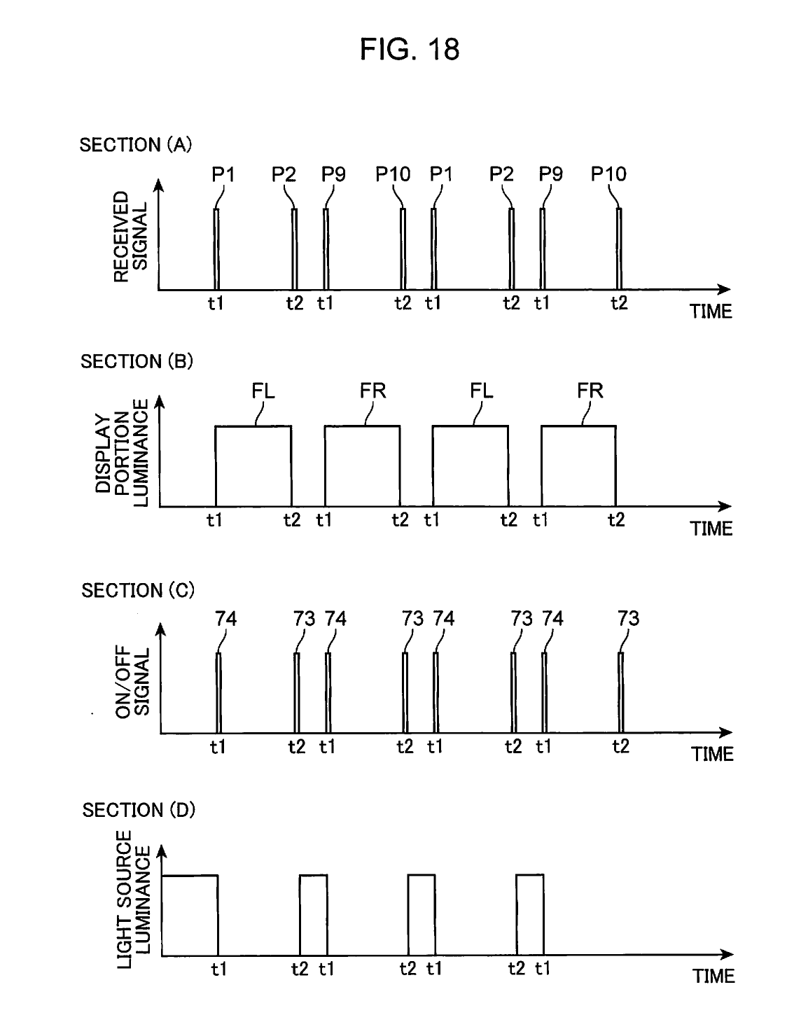

FIG. 18 is a timing chart schematically showing a blinking control on the light source 21 performed by the illumination controller 20A in accordance with the fourth embodiment. The section (A) of FIG. 18 shows signals received by the first receiver 230. The second (B) of FIG. 18 shows a luminance of the display portion 310. The section (C) of FIG. 18 shows on/off-signals generated by the first generator 242. The section (D) of FIG. 18 shows a luminance of the light source 21. The blinking control on the light source 21 is described with reference to FIGS. 1, 2, 4, 6, 13, 17 and 18.

The first receiver 230 sequentially receives the synchronization signal including the bit serial P1, the synchronization signal including the bit serial P2, the synchronization signal including the bit serial P9 and the synchronization signal including the bit serial P10. As described in the context of FIG. 18, the synchronization signals including the bit serials P1, P9 are used as the first synchronization signals in synchronism with the display starts of the frame images FL, FR, respectively. The synchronization signal including the bit serial P1 synchronizes with the display start of the left frame image FL. The synchronization signal including the bit serial P9 synchronizes with the display start of the right frame image FR. Similarly, the synchronization signals including the bit serials P2, P10 are used as the second synchronization signals in synchronism with the display ends of the frame images FL, FR. The synchronization signal including the bit serial P2 synchronizes with the display end of the left frame image FL. The synchronization signal including the bit serial P10 synchronizes with the display end of the right frame image FR.

The first analyzer 241 of the illumination controller 20A measures the reception time t1 of the first synchronization signal (the synchronization signal including the bit serial P1 or P9), and the reception time t2 of the second synchronization signal (the synchronization signal including the bit serial P2 or P10). The first analyzer 241 determines a time period from the time t1, at which the first synchronization signal is received, to the time t2, at which the second synchronization signal is received, as the first period during which the light source 21 is darkened. The first analyzer 241 determines a time period from when the second synchronization signal is received to when the next first synchronization signal is received as the second period, during which the light source 21 is brightened.

The first generator 242 generates the on-signal 73 at the time t2 at which the second synchronization signal is received and the off-signal 74 at the time t1 in synchronism with the reception of the first synchronization signal. The light source controller 243 controls the light source 21 in response to the on-signal 73 and the off-signal 74 which are generated by the first generator 242. The light source 21 is darkened during the first period and brightened during the second period according to the determination by by the first analyzer 241.

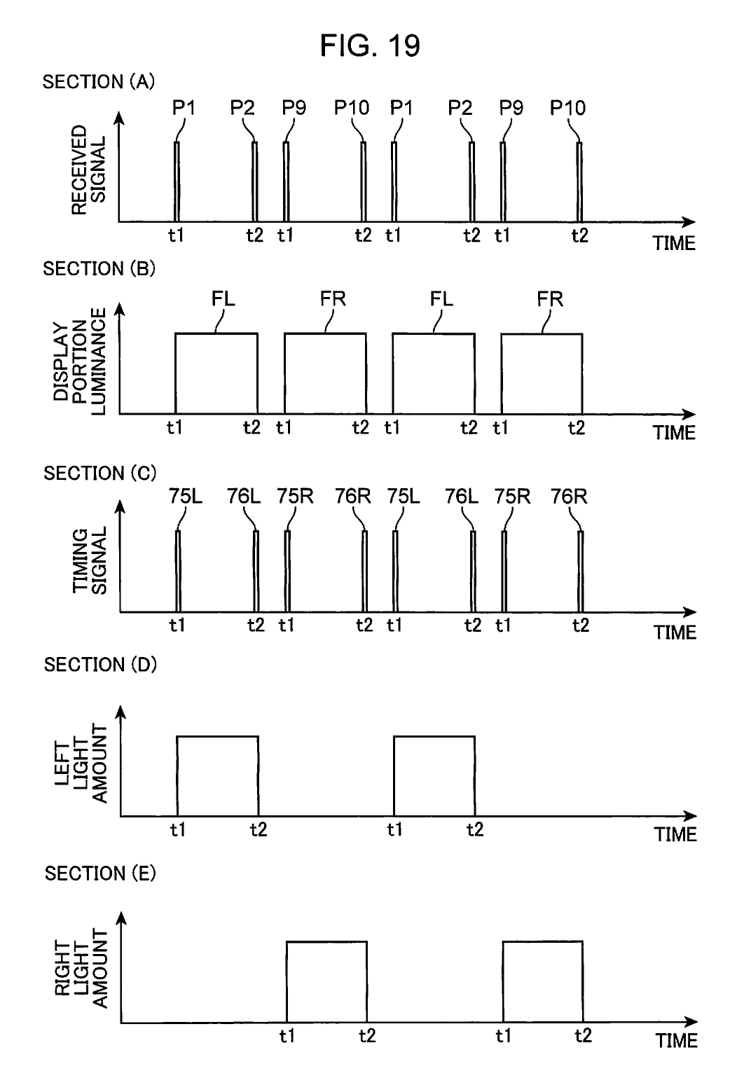

FIG. 19 is a timing chart schematically showing a control for the stereoscopic vision assistance of the optical filter portion 43. The section (A) of FIG. 19 shows signals received by the second receiver 440. The section (B) of FIG. 19 shows a luminance of the display portion 310. The section (C) of FIG. 19 shows timing signals, which are generated by the second generator 453 to make the optical filter portion 43 perform the stereoscopic vision assistance. The section (D) of FIG. 19 shows variation in light amount which passes through the left filter 41 and reaches the viewer's left eye. The section (E) of FIG. 19 shows variation in light amount which passes through the right filter 42 and reaches the viewer's right eye. The control for the stereoscopic vision assistance of the optical filter portion 43 is described with reference to FIGS. 1, 2, 4, 8 and 13 as well as FIGS. 17 to 19.

The second receiver 440 sequentially receives the synchronization signals including the bit serials P1, P2, P9 and P10. As described in the context of FIG. 18, the synchronization signals including the bit serials P1, P9 are used as the first synchronization signals in synchronism with the display starts of the frame images FL, FR, respectively. The synchronization signal including the bit serial P1 synchronizes with the display start of the left frame image FL. The synchronization signal including the bit serial P9 synchronizes with the display start of the right frame image FR. Similarly, the synchronization signals including the bit serials P2, P10 are used as the second synchronization signals in synchronism with the display ends of the frame images FL, FR, respectively. The synchronization signal including the bit serial P2 synchronizes with the display end of the left frame image FL. The synchronization signal including the bit serial P10 synchronizes with the display end of the right frame image FR.

The second analyzer 452 of the eyeglass device 4A measures the reception time t1 of the first synchronization signal (the synchronization signal including the bit serial P1 or P9) and the reception time t2 of the second synchronization signal (the synchronization signal including the bit serial P2 or P10).

The second generator 453 generates a timing signal 75L for increasing the light amount passing through the left filter 41 at the reception time t1 of the synchronization signal including the bit serial P1 in synchronism with the display start of the left frame image FL. The second generator 453 generates a timing signal 76L for decreasing the light amount passing through the left filter 41 at the reception time t2 of the synchronization signal including the bit serial P2 in synchronism with the display end of left frame image FL. Similarly, the second generator 453 generates a timing signal 75R for increasing the light amount passing through the right filter 42 at the reception time t1 of the synchronization signal including the bit serial P9 in synchronism with the display start of the right frame image FR. The second generator 453 generates a timing signal 76R for decreasing the light amount passing through the right filter 42 at the reception time t2 of the synchronization signal including the bit serial P10 in synchronism with the display end of the right frame image FR.

The optical filter controller 454 controls the optical filter portion 43 in response to the timing signals 75L, 76L, 75R and 76R generated by the second generator 453. The left filter 41 increases the light amount transmitted to the left eye in response to the timing signal 75L and decreases the light amount transmitted to the left eye in response to the timing signal 76L. Similarly, the right filter 42 increases the light amount transmitted to the right eye in response to the timing signal 75R and decreases the light amount transmitted to the right eye in response to the timing signal 76R.

A series of the operations described in the context of FIGS. 18 and 19 works to achieve the display and switching operation of the frame images FL, FR in the display panel 31 and the synchronization between the light source 21 and the optical filter portion 43, as described in the context of FIG. 2.

### Fifth Embodiment

An illumination system 1A and an eyeglass device 4B in accordance with the fifth embodiment are described hereinafter. Unlike the first to fourth embodiments, in the fifth embodiment, the blinking control on the light source 21 is executed in response to signals, which are transmitted from the eyeglass device 4B. Differences from the illumination systems 1A and the eyeglass devices 4A in accordance with the first to fourth embodiments are mainly shown hereinafter as descriptions of the illumination system 1A and the eyeglass device 4B in accordance with the fifth embodiment.

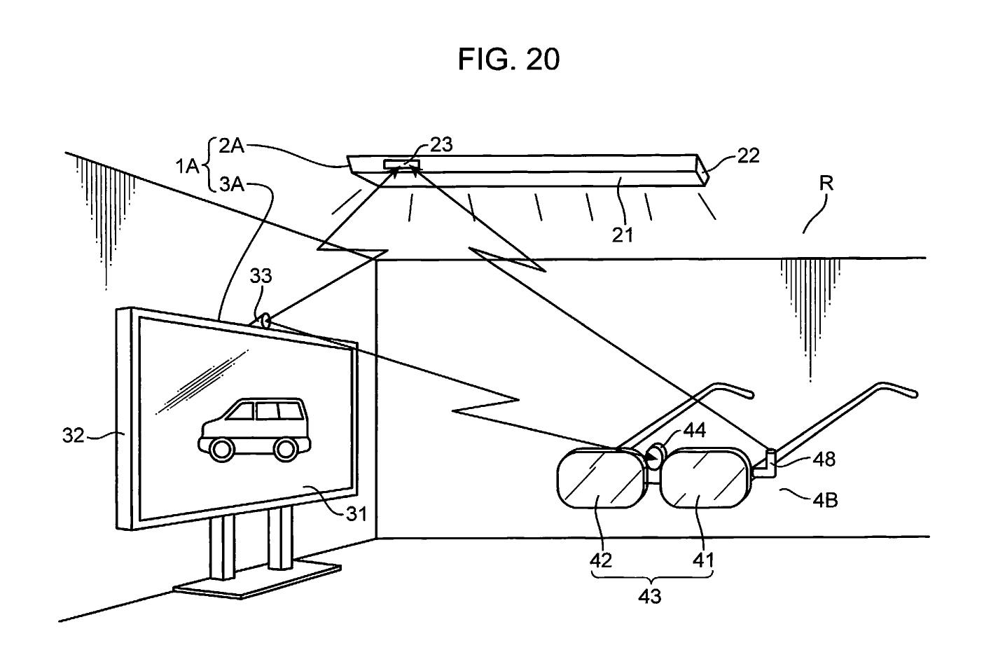

FIG. 20 schematically shows the illumination system 1A and the eyeglass device 4B in accordance with the fifth embodiment. Unlike the eyeglass device 4A used in the first to fourth embodiments, the eyeglass device 4B used in the fifth embodiment includes a second transmission device 48. The reception device 23 of the illumination system 1A receives signals from the second transmission device 48 of the eyeglass device 4B, in addition to the signals from the display device 3A used in the first to fourth embodiments.

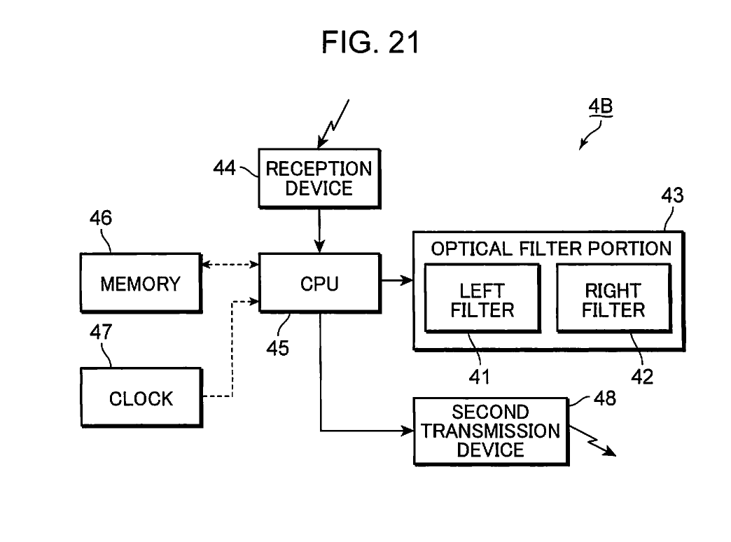

FIG. 21 is a block diagram schematically showing a hardware configuration of the eyeglass device 4B. Differences from the hardware configuration of the eyeglass device 4A shown in FIG. 7 are described with reference to FIG. 21.

The eyeglass device 4B includes the aforementioned second transmission device 48, in addition to the CPU 45, the memory 46, the clock 47, the reception device 44 and the optical filter portion 43. Operations and functions of the CPU 45, the memory 46, the clock 47, the reception device 44 and the optical filter portion 43 are the same as those described in the context of FIG. 7.

The second transmission device 48 transmits a third signal in synchronism with an operation start of the left or right filter 41, 42 to decrease the light amount transmitted to the left or right eye under control of the CPU 45. Therefore, the third signal includes the third information on the timing for the optical filter portion 43 to decrease the light amount.

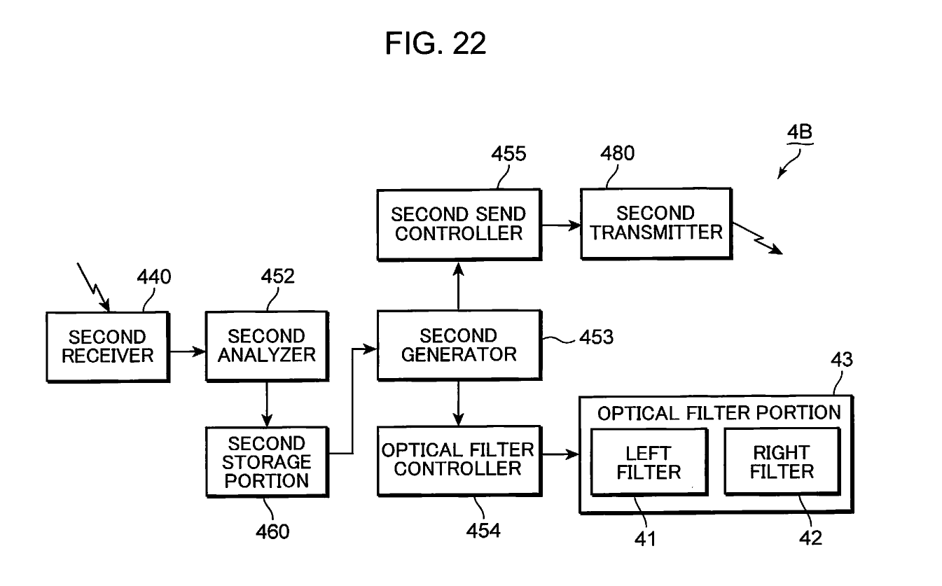

FIG. 22 is a block diagram schematically showing a functional configuration of the eyeglass device 4B. Differences from the functional configuration of the eyeglass device 4A shown in FIG. 8 are described with reference to FIG. 22.

The eyeglass device 4B includes a second transmission controller 455 and a second transmitter 480, in addition to the second receiver 440, the second analyzer 452, the second storage portion 460, the second generator 453, the optical filter controller 454 and the optical filter portion 43. Operations and functions of the second receiver 440, the second analyzer 452, the second storage portion 460, the optical filter controller 454 and the optical filter portion 43 are the same as those described in the context of FIG. 8.

The second generator 453 generates timing signals on the basis of the synchronization information analyzed by the second analyzer 452 as described in the context of FIG. 8. The second generator 453 outputs the timing signals to the second transmission controller 455 in addition to the optical filter controller 454. The second generator 453 corresponds to the CPU 45 and the clock 47 in the hardware configuration shown in FIG. 21.

The timing signals generated by the second generator 453 include the timing signals for executing the control for increasing the light amounts passing through the left and right filters 41, 42, and the timing signals for executing the control for decreasing the light amounts passing through the left and right filters 41, 42. The second transmission controller 455 selects the timing signals for executing the control for decreasing the light amounts passing through the left and right filters 41, 42 from the timing signals generated by the second generator 453 and causes the second transmitter 480 to send the selected timing signal. The second transmission controller 455 corresponds to the CPU 45 in the hardware configuration shown in FIG. 21. The second transmitter 480 corresponds to the second transmission device 48 in the hardware configuration shown in FIG. 21.

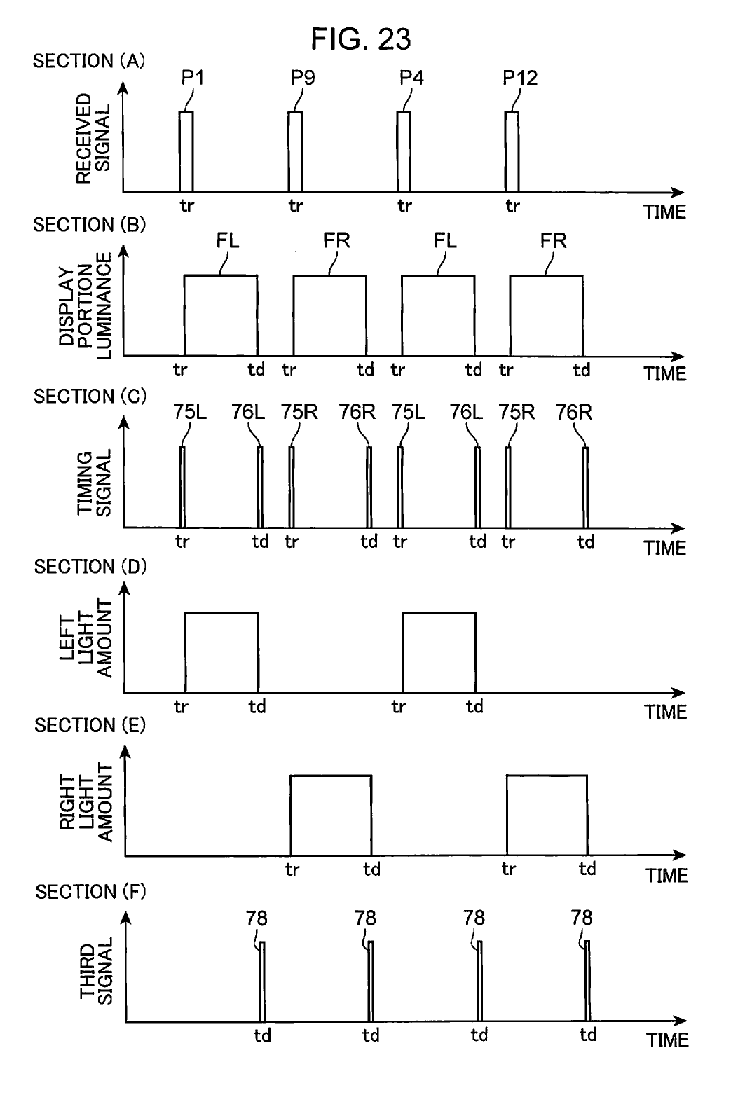

FIG. 23 is a timing chart schematically showing the control on the optical filter portion 43 in accordance with the fifth embodiment. The section (A) of FIG. 23 shows signals received by the second receiver 440. The section (B) of FIG. 23 shows a luminance of the display portion 310. The section (C) of FIG. 23 shows timing signals which are generated by the second generator 453 to make the optical filter portion 43 perform the stereoscopic vision assistance. The section (D) of FIG. 23 shows variation in light amount which passes through the left filter 41 and reaches the viewer's left eye. The section (E) of FIG. 23 shows variation in light amount which passes through the right filter 42 and reaches the viewer's right eye. The section (F) of FIG. 23 shows the third signals transmitted from the second transmitter 480. The processes from the reception of the synchronization signal, which is sent from the display device 3A, to the control of the stereoscopic vision assistance of the optical filter portion 43 shown in FIG. 23 is the same as those described in the context of FIG. 16. Therefore, in the present embodiment, transmission of the third signals from the second transmitter 480 is shown as descriptions of the control on the optical filter portion 43 in accordance with the fifth embodiment with reference to FIGS. 2, 4, 13, 14 and 16 as well as FIGS. 20 to 23.

The second receiver 440 sequentially receives the synchronization signals including the bit serials P1, P9, P4 and P12. As described in the context of FIG. 14, the synchronization signals including the bit serials P1, P4 are received in synchronism with the display start of the left frame image FL, respectively. The synchronization signals including the bit serials P9, P12 are received in synchronism with the display start of the right frame image FR, respectively.

The second generator 453 of the eyeglass device 4B generates the timing signals 75L and 75R to increase the light amount passing through the left and right filter 41, 42 at the reception time tr of the synchronization signals including the bit serials P1, P9, P4 and P12, respectively. The second generator 453 generates the timing signals 76L and 76R to decrease the light amounts passing through the left and right filters 41, 42 at the times td calculated from the display time periods per frame image assigned to bit serials P1, P9, P4 and P12 of the synchronization signals and the times td calculated on the basis of the reception times tr of the synchronization signals, respectively.

The optical filter controller 454 controls the optical filter portion 43 in response to the timing signals 75L, 76L, 75R and 76R generated by the second generator 453. The left filter 41 increases the light amount transmitted to the left eye in response to the timing signal 75L and decreases the light amount transmitted to the left eye in response to the timing signal 76L. Similarly, the right filter 42 increases the light amount transmitted to the right eye in response to the timing signal 75R and decreases the light amount transmitted to the right eye in response to the timing signal 76R.

The second transmission controller 455 causes the second transmitter 480 to transmit the third signal 78 in response to (in synchronism with) the timing signal 76L or 76R for decreasing the light amount passing through the left or right filter 41, 42. Thus, the third signal 78 is transmitted from the second transmitter 480 at the time td.

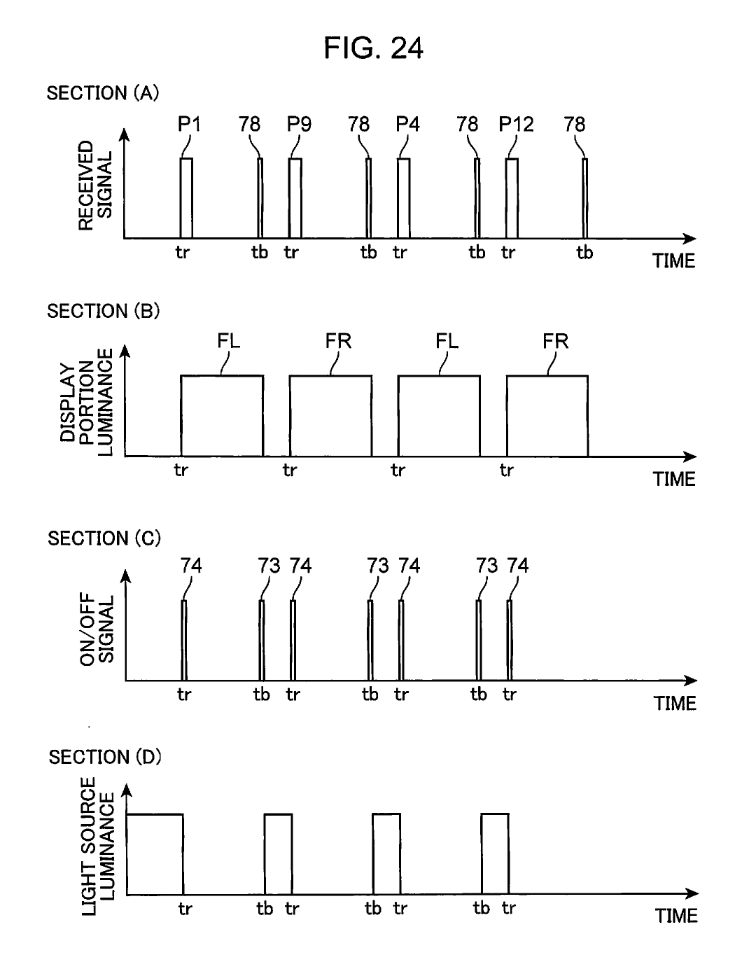

FIG. 24 is a timing chart schematically showing a blinking control on the light source 21 performed by the illumination controller 20A in accordance with the fifth embodiment. The section (A) of FIG. 24 shows signals received by the first receiver 230. The section (B) of FIG. 24 shows a luminance of the display portion 310. The section (C) of FIG. 24 shows on/off-signals generated by the first generator 242. The section (D) of FIG. 24 shows a luminance of the light source 21. The blinking control on the light source 21 is described with reference to FIGS. 2 and 4, FIGS. 13 to 15 and FIGS. 20 to 24.

The first receiver 230 receives the synchronization signals including the bit serials P1, P9, P4 and P12 as described in the context of FIG. 15. As described in the context of FIG. 14, the synchronization signals including the bit serials P1, P4 are received in synchronism with the display start of the left frame image FL. The synchronization signals including the bit serials P9, P12 are received in synchronism with the display start of the right frame image FR. The first receiver 230 further receives the third signals 78 transmitted from the second transmitter 480 of the eyeglass device 4B while the first receiver 230 receives each synchronization signal as described in the context of FIG. 23. It should be noted that the third signal 78 preferably has a different waveform from the synchronization signal.

The first analyzer 241 of the illumination controller 20A measures the reception times tr of the synchronization signals including the bit serials P1, P9, P4 and P12, respectively. The first analyzer 241 measures the reception time tb of the third signal 78 (substantially the same time as the transmission time td of the third signal 78). The first analyzer 241 determines a time period from the reception time tr of the synchronization signal to the reception time tb of the third signal 78 as the first period, during which the light source 21 is darkened. The first analyzer 241 determines a time period from the reception time tb of the third signal 78 to the time tr at which the next synchronization signal is received as the second period, during which the light source 21 is brightened.

The first generator 242 generates the on-signal 73 at the reception time tb of the third signal and the off-signal 74 at the reception time tr of the synchronization signal. The light source controller 243 controls the light source 21 in response to the on-signal 73 and the off-signal 74, which are generated by the first generator 242. The light source 21 is darkened during the first period and brightened during the second period according to the determination by the first analyzer 241.

A series of the operations described in the context of FIGS. 23 and 24 works to achieve the display and switching operation of the frame images FL, FR in the display panel 31 and the synchronization between the light source 21 and the optical filter portion 43, as described in the context of FIG. 2.

Apparently, the principles in accordance with the fifth embodiment are also similarly achieved even by using the communication methodologies of the synchronization signals between the display device 3A and the eyeglass device 4A described in the context of the first and second embodiments. Alternatively, the principles are also similarly achieved even by using the communication methodologies of the synchronization signals between the display device 3A and the eyeglass device 4A described in the context of the fourth embodiment. With the communication methodologies of the synchronization signals between the display device 3A and the eyeglass device 4A in accordance with the fourth embodiment, the third signal 78 may be a different kind of signal from the synchronization signal. For example, if the synchronization signal is an RF signal, the third signal 78 may be an infrared signal. Alternatively, if the synchronization signal is an infrared signal, the third signal 78 may be an RF signal. The first receiver 230 of the illumination controller 20A may be implemented by using, for example, one of reception devices for RF signals and infrared signals to suitably prevent interference between the synchronization signal sent from the display device 3A to the illumination controller 20A and the third signal sent from the eyeglass device 4B to the illumination controller 20A.

### Sixth Embodiment

An illumination system 1B and an eyeglass device 4A in accordance with the sixth embodiment are described hereinafter. Unlike the first to fourth embodiments, in the sixth embodiment, the blinking control on the light source 21 is executed on the basis of luminance information on a luminance of the display portion 310 of the display device 3A. Differences from the illumination systems 1A and the eyeglass devices 4A in accordance with the first to fifth embodiments are mainly shown as descriptions of the illumination system 1B and the eyeglass device 4A in accordance with the sixth embodiment.

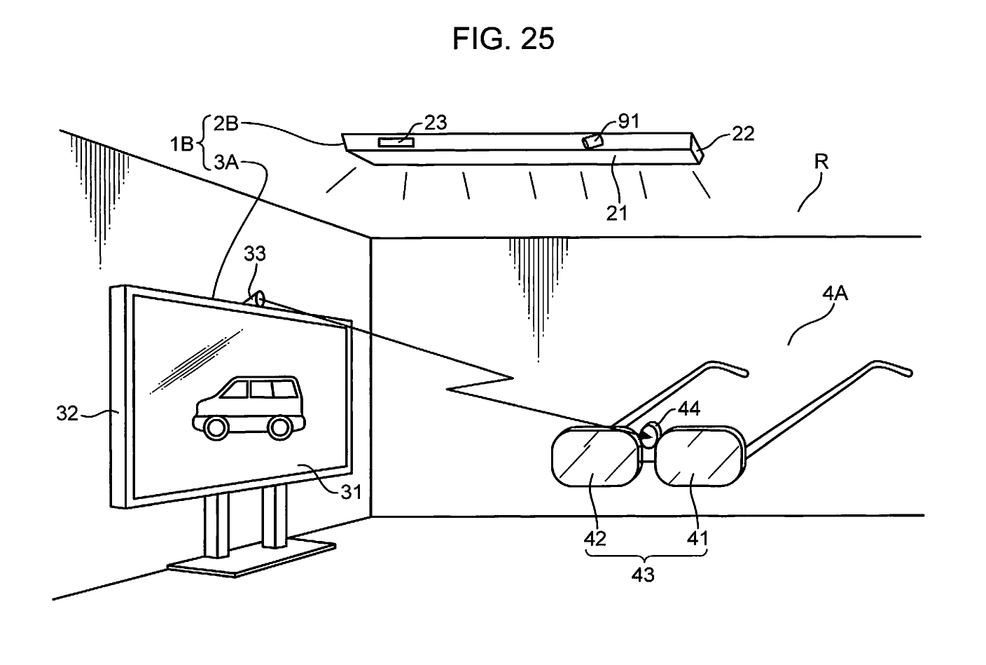

FIG. 25 schematically shows the illumination system 1B and the eyeglass device 4A in accordance with the sixth embodiment. The illumination system 1B used in the sixth embodiment includes the illuminator 2B in addition to the display device 3A used in the first to fifth embodiments. The illuminator 2B includes a luminance sensor 91 configured to detect the luminance of the whole display panel 31 of the display device 3A. The blinking control of the light source 21 described in the context of FIG. 2 is executed on the basis of the luminance information on the luminance of the display panel detected by the luminance sensor 91.

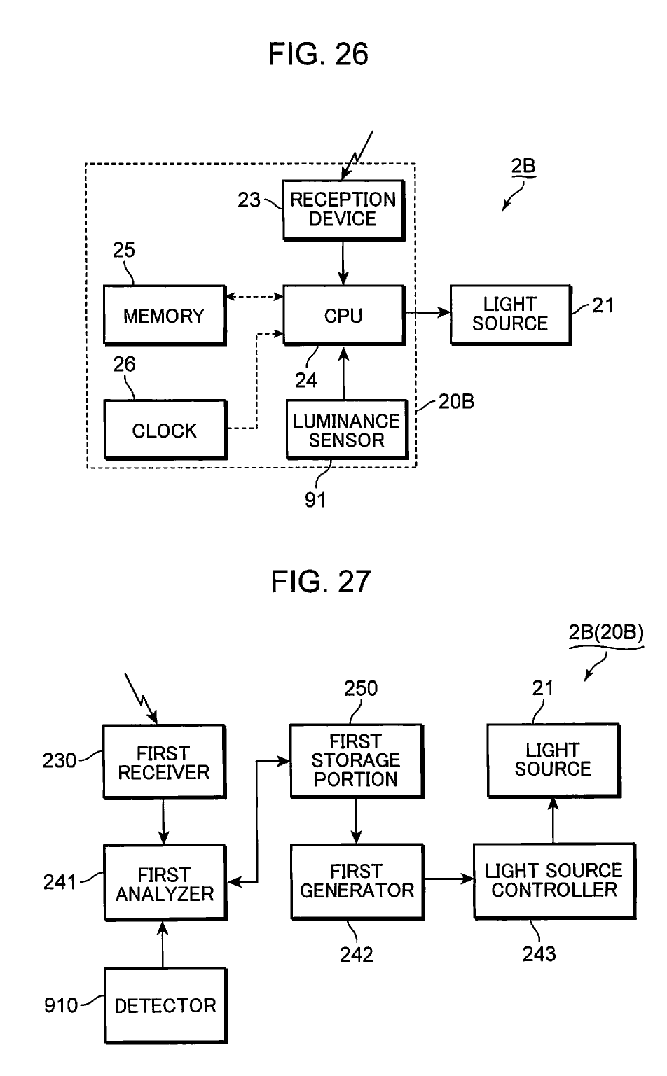

FIG. 26 is a block diagram schematically showing a hardware configuration of the illuminator 2B and the illumination controller integrated in the illuminator 2B in accordance with the sixth embodiment. Differences from the hardware configurations of the illuminator 2A and the illumination controller integrated in the illuminator 2A described in the context of FIG. 5 are mainly described with reference to FIGS. 25 and 26.

The illuminator 2B includes the illumination controller 20B in addition to the light source 21. The illumination controller 20B includes the luminance sensor 91 in addition to the CPU 24, the memory 25, the clock 26 and the reception device 23. Operations and functions of the CPU 24, the memory 25, the clock 26 and the reception device 23 are the same as those described in the context of FIG. 5.

As described in the context of FIG. 25, the luminance sensor 91 detects the luminance of the whole display panel 31 of the display device 3A. The CPU 24 executes the blinking control of the illumination controller 20B in response to output signals from the reception device 23 and the luminance sensor 91.

FIG. 27 is a block diagram schematically showing a functional configuration of the illuminator 2B. Differences from the functional configuration of the illuminator 2A and the illumination controller 20A described in the context of FIG. 6 are mainly described with reference to FIGS. 25 to 27.

The illuminator 2B includes a detector 910 in addition to the first receiver 230, the first analyzer 241, the first storage portion 250, the first generator 242, the light source controller 243 and the light source 21. Operations and functions of the first receiver 230, the first analyzer 241, the first storage portion 250, the first generator 242, the light source controller 243 and the light source 21 are the same as those described in the context of FIG. 6.

The detector 910 detects the luminance of the whole display portion 310 of the display device 3A. The first analyzer 241 determines the first period, during which the light source 21 is darkened, and the second period, during which the light source 21 is brightened, in response to signals received by the first receiver 230 and signals from the detector 910.

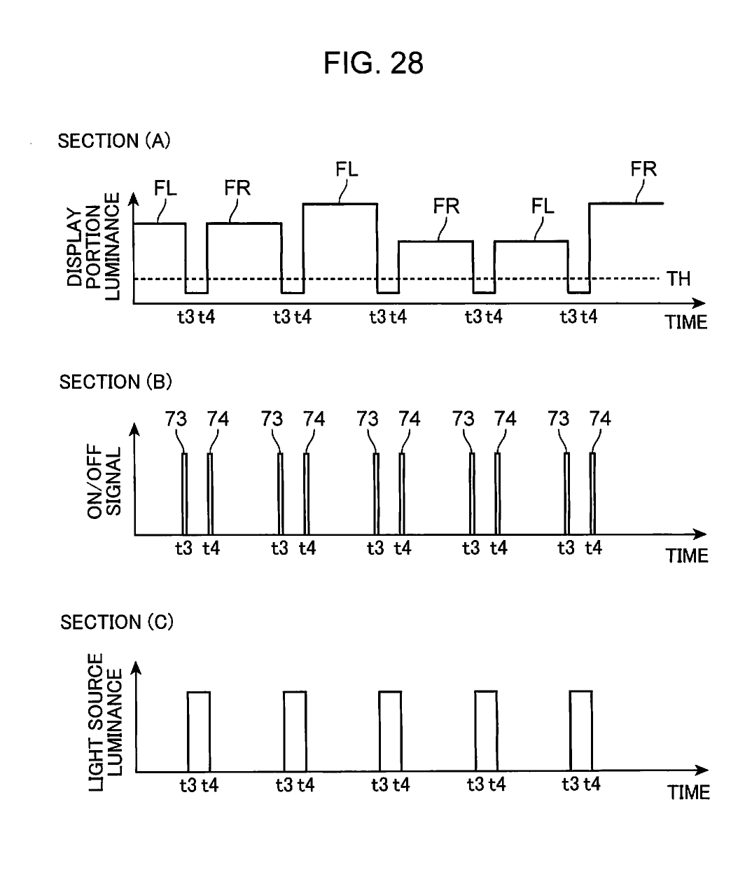

FIG. 28 is a schematic view showing the blinking control on the light source 21 performed by the illumination controller 20B in accordance with the sixth embodiment. The section (A) of FIG. 28 shows variation in luminance of the display portion 310. The section (B) of FIG. 28 shows on/off-signals generated by the first generator 242. The section (C) of FIG. 28 shows a luminance of the light source 21. The blinking control on the light source 21 is described with reference to FIGS. 2, 6 and 8 as well as FIGS. 26 to 28.

As described above, the detector 910 detects the luminance of the display portion 310. Therefore, in the present embodiment, the detector 910 has functions as the acquisition portion for acquiring the information on the luminance of the display portion 310. As described in the context of FIG. 2, the luminance of the display portion 310 shows a high value while the left or right frame image FL, FR is displayed and a low value during the non-display period in which the switching operation between the left and right frame images FL, FR is performed. The first storage portion 250 stores a threshold value TH for the luminance of the display portion 310. The first analyzer 241 compares the threshold value TH with the luminance value detected by the detector 910.

The first analyzer 241 measures the time t3 at which the luminance value becomes smaller than the threshold value TH and the time t4 at which the luminance value becomes higher than the threshold value TH, respectively. The first analyzer 241 determines a time period during which the luminance value is larger than the threshold value TH (the time period from the time t4 to the time t3) as the first period, during which the light source 21 is darkened. The first analyzer 241 determines a time period during which the luminance value is lower than the threshold value TH (the time period from the time t4 to the time t3) as the second period, during which the light source 21 is brightened. The first generator 242 generates the on-signal 73 so that the light source 21 is started to brighten at the time t3. The first generator 242 generates the off-signal 74 so that the light source 21 is darkened at the time t4. The light source controller 243 controls the light source 21 in response to the on-signal 73 and the off-signal 74 generated by the first generator 242. The light source 21 is darkened during the first period and brightened during the second period according to the determination by the first analyzer 241.

The communication between the display device 3A and the eyeglass device 4A may be executed according to the methodologies described in the context of the first to fifth embodiments. Thus, the display and switching operation of the frame images FL, FR and the synchronization between the light source 21 and the optical filter portion 43 is achieved as described in the context of FIG. 2.

### Seventh Embodiment

An illumination system 1C and an eyeglass device 4A in accordance with the seventh embodiment are described hereinafter. Unlike the first to sixth embodiments, the seventh embodiment allows to adjust a brightening period of the light source 21. It should be noted that in the seventh embodiment, the communication among the display device 3A, the illuminator 2C and the eyeglass device 4A is executed according to the methodologies described in the context of the first to sixth embodiments. The adjustment methodologies of the brightening period of the light source 21 are described hereinafter as the seventh embodiment.

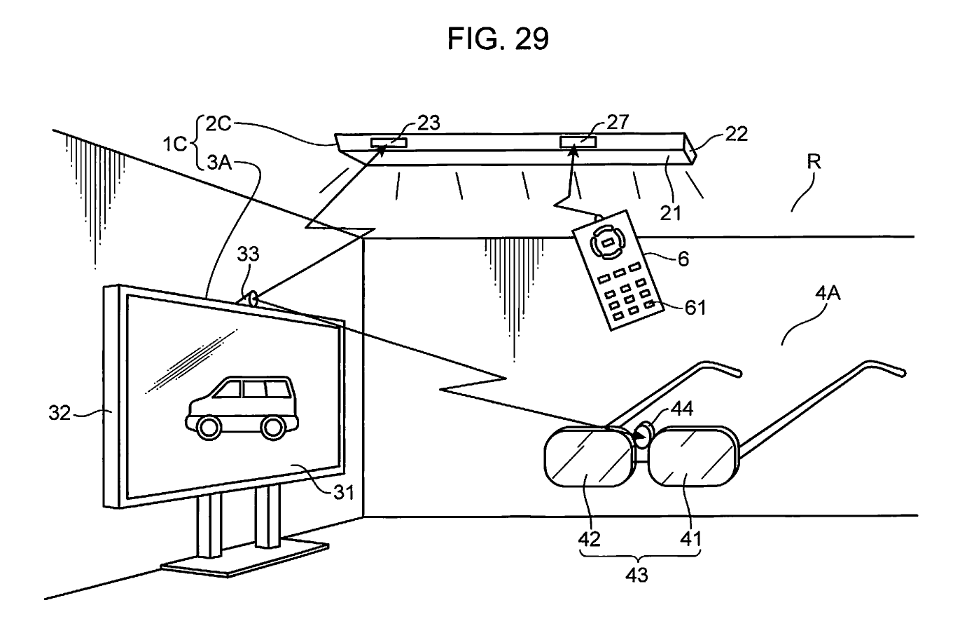

FIG. 29 schematically shows the illumination system 1C and the eyeglass device 4A in accordance with the seventh embodiment. In the seventh embodiment, a remote controller 6 is used for the adjustment of the brightening period of the light source 21. If a viewer wants to view a video on the display panel 31 in a bright environment or a dark environment, the viewer may operate the remote controller 6 to send a fourth signal for adjusting a length of the brightening period of the light source 21. If other users who do not view the stereoscopic video provided by the display device 3A want to change a degree of brightness/darkness in the space R where the display device 3A is placed, the users may operate the remote controller 6 to send the fourth signal for adjusting the length of the brightening period of the light source 21. The remote controller 6 includes a button 61 configured to receive viewers' and other users' requests.

The illumination controller integrated in the illuminator 2C includes a request reception device 27 configured to receive the fourth signal. If the signal sent from the display device 3A is an RF signal, the fourth signal may be an infrared signal. If the signal sent from the display device 3A is an infrared signal, the fourth signal may be an RF light signal. Thus, the signal from the display device 3A is different in type from the remote controller 6. Therefore it becomes less likely that there is interference between the signals.

In the present embodiment, the remote controller 6 is used to transmit the viewers' and other users' requests to the illuminator 2C. Alternatively, the eyeglass device 4A and the display device 3A may be configured to allow input or output of the viewers' and other users' requests so that the viewers' and other users' requests is transmitted to the illuminator 2C.

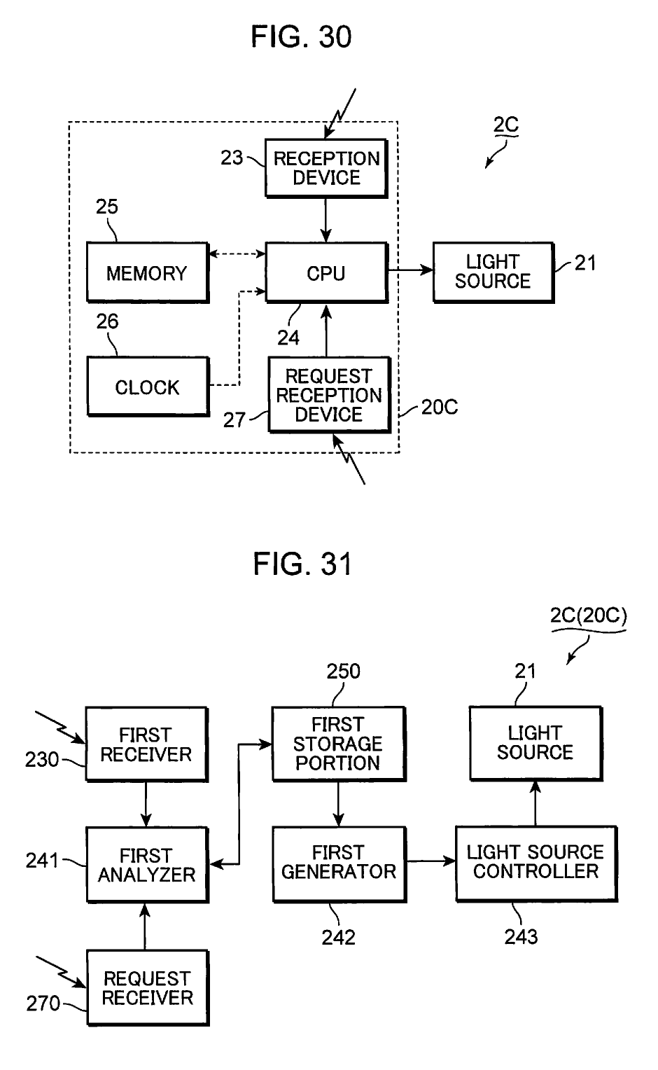

FIG. 30 is a block diagram schematically showing a hardware configuration of the illuminator 2C and the illumination controller integrated in the illuminator 2C in accordance with the seventh embodiment. Differences from the hardware configurations of the illuminator 2A and the illumination controller integrated in the illuminator 2A described in the context of FIG. 5 are described with reference to FIGS. 29 and 30.

The illuminator 2C includes the light source 21 and the illumination controller 20C. The illumination controller 20C includes a request reception device 27 in addition to the CPU 24, the memory 25, the clock 26 and the reception device 23. Operations and functions of the CPU 24, the memory 25, the clock 26 and the reception device 23 are the same as those described in the context of FIG. 5.

As described in the context of FIG. 29, the request reception device 27 receives the fourth signal from the remote controller 6. The CPU 24 executes the blinking control of the illumination controller 20C in response to signals received by the reception device 23 and the request reception device 27.

FIG. 31 is a block diagram schematically showing a functional configuration of the illuminator 2C. Differences from the functional configurations of the illuminator 2A and the illumination controller 20A described in the context of FIG. 6 are described with reference to FIGS. 29 to 31.

The illuminator 2C includes a request receiver 270 in addition to the first receiver 230, the first analyzer 241, the first storage portion 250, the first generator 242, the light source controller 243 and the light source 21. Operations and functions of the first receiver 230, the first analyzer 241, the first storage portion 250, the first generator 242, the light source controller 243 and the light source 21 are the same as those described in the context of FIG. 6.

The request receiver 270 receives the fourth signal from the remote controller 6. The first analyzer 241 determines the first period, during which the light source 21 is darkened, and the second period, during which the light source 21 is brightened, on the basis of signals received by the first receiver 230 and the fourth signal received by the request receiver 270.

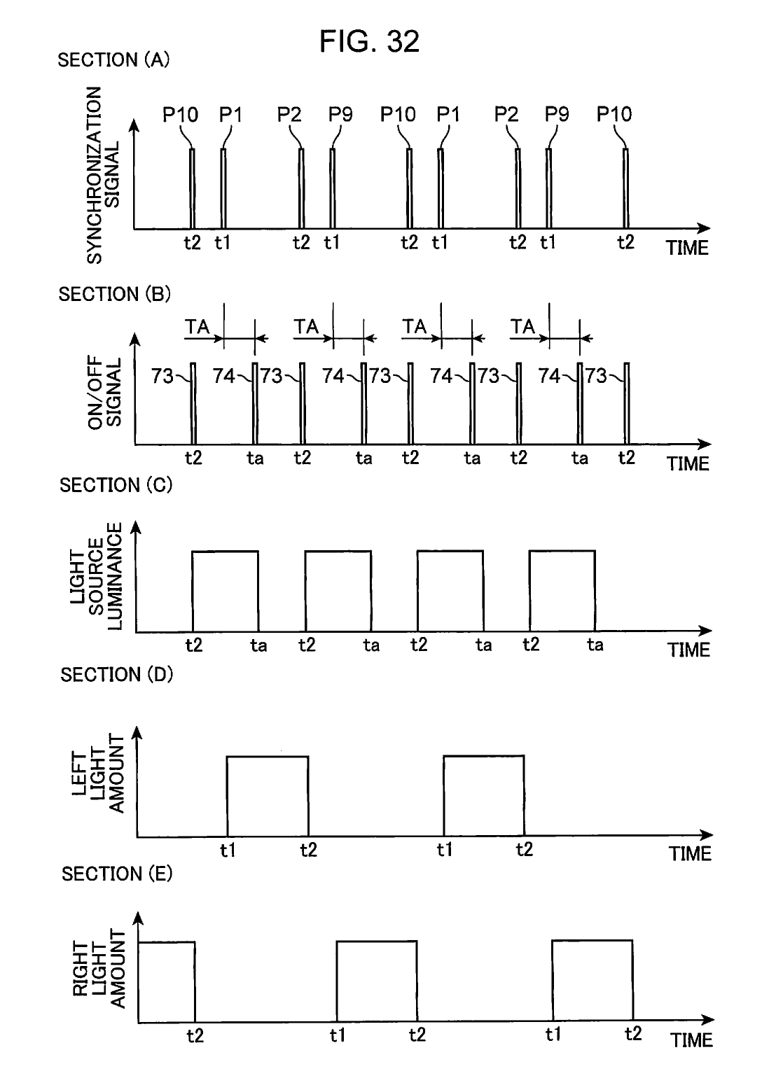

FIG. 32 is a timing chart schematically showing the blinking control on the light source 21 performed by the illumination controller 20C in accordance with the seventh embodiment. The section (A) of FIG. 32 shows the synchronization signals sent from the display device 3A. The section (B) of FIG. 32 shows the on/off-signals generated by the first generator 242 of the illumination controller 20C. The section (C) of FIG. 32 shows a luminance of the light source 21. The second (D) of FIG. 32 shows variation in light amount which passes through the left filter 41 and reaches the viewer's left eye. The section (E) of FIG. 32 shows variation in light amount which passes through the right filter 42 and reaches the viewer's right eye. The blinking control on the light source 21 performed by the illumination controller 20C in accordance with the seventh embodiment is described with reference to FIGS. 4, 13, 17 and 18 as well as FIGS. 29 to 32.

Like the fourth embodiment, the display portion 310 of the display device 3A transmits the synchronization signals including the bit serials P1, P2, P9 and P10 as shown in the section (A) of FIG. 32. As described in the context of FIG. 18, the synchronization signals including the bit serials P1, P9 are used as the first synchronization signals in synchronism with the display starts of the frame images FL, FR, respectively. The synchronization signal including the bit serial P1 synchronizes with the display start of the left frame image FL whereas the synchronization signal including the bit serial P9 synchronizes with the display start of the right frame image FR. Similarly, the synchronization signals including the bit serials P2, P10 are used as the second synchronization signals in synchronism with the display ends of the frame images FL, FR, respectively. The synchronization signal including the bit serial P2 synchronizes with the display end of the left frame image FL. The synchronization signal including the bit serial P10 synchronizes with the display end of the right frame image FR. As described in the context of the fourth embodiment, the optical filter portion 43 increases or decreases the light amount transmitted to the viewer's left or right eye.

As described in the context of the fourth embodiment, the first analyzer 241 of the illumination controller 20C measures the reception time t1 of the first synchronization signal (the synchronization signal including the bit serial P1 or P9) and the reception time t2 of the second synchronization signal (the synchronization signal including the bit serial P2 or P10).

The fourth signal from the remote controller 6 includes fourth information on the viewers' or other users' requests. In the present embodiment, the delay time TA from the reception time t1 of the first synchronization signal is used as the fourth information. The first analyzer 241 adds the delay time TA to the reception time t1, and calculates the time ta to generate the off-signal 74. The first analyzer 241 determines a time period from the calculated time ta to the time t2 at which the second synchronization signal is received as the first period, during which the light source 21 is darkened. The first analyzer 241 determines a time period from the time t2 at which the second synchronization signal is received to the immediately subsequent time ta as the second period, during which the light source 21 is brightened.

The first generator 242 generates the on-signal 73 at the time t2 in synchronism with the reception of the second synchronization signal and the off-signal 74 at the calculated time ta. The light source controller 243 controls the light source 21 in response to the on-signals 73 and the off-signals 74 generated by the first generator 242. The light source 21 is darkened during the first period and brightened during the second period according to the determination by the first analyzer 241.

As described in FIG. 32, the space R where the display device 3A is placed becomes brighter by the delay time TA. Therefore, viewers or other users may operate the remote controller 6 to increase or decrease the delay time TA, so that the space R becomes brighter or darker.

During the time period from the time t1 to the time ta, the light source 21 is brightened. Meanwhile, the left or right filter 41, 42 allows an increased light amount to transmit to the left or right eye. Therefore, a viewer may operate the remote controller 6 to lengthen or shorten the delay time TA, so that the viewer may adjust the degree of brightness/darkness of the viewing environment of the left and right frame images FL, FR.

In the description of the present embodiment, the communication methodologies of the synchronization signals described in the context of the fourth embodiment is used. Alternatively, the communication methodologies of the synchronization signals described in the context of the other embodiments may be applied to the present embodiment. For example, the blinking control described in the context of FIG. 32 may be achieved if the delay time included in the fourth signal sent from the remote controller 6 is added to the generation time of the off-signal calculated from the information included in the first signal 71 (see FIG. 9) and the second signal 77 (see FIG. 11), which are described in the context of the first and second embodiments. The blinking control described in the context of FIG. 32 may be also achieved if the delay time included in the fourth signal sent from the remote controller 6 is added to the generation time of the off-signal calculated from the information included in the synchronization signal used in the third embodiment. The blinking control described in the context of FIG. 32 may be also achieved if the delay time included in the fourth signal is added to the reception time of the third signal from the eyeglass device 4A used in the fifth embodiment. The blinking control described in the context of FIG. 32 may be also achieved if the delay time included in the fourth signal sent from the remote controller 6 is added to the generation time of the off-signal determined by comparison between the luminance signal from the display device 3A used in the sixth embodiment and the threshold value set for the luminance.

### Eighth Embodiment

An illumination system 1C and an eyeglass device 4A in accordance with the eighth embodiment are described hereinafter. Unlike the seventh embodiment, the length of the brightening period of the light source 21 is not changed in the eighth embodiment but the timing of the brightening period of the light source 21 is changed. It should be noted that the illumination system 1C, the eyeglass device 4A and the remote controller 6 in accordance with the eighth embodiment are substantially the same as the illumination system 1C, the eyeglass device 4A and the remote controller 6 described in the context of the seventh embodiment. Differences from the seventh embodiment are mainly described hereinafter.

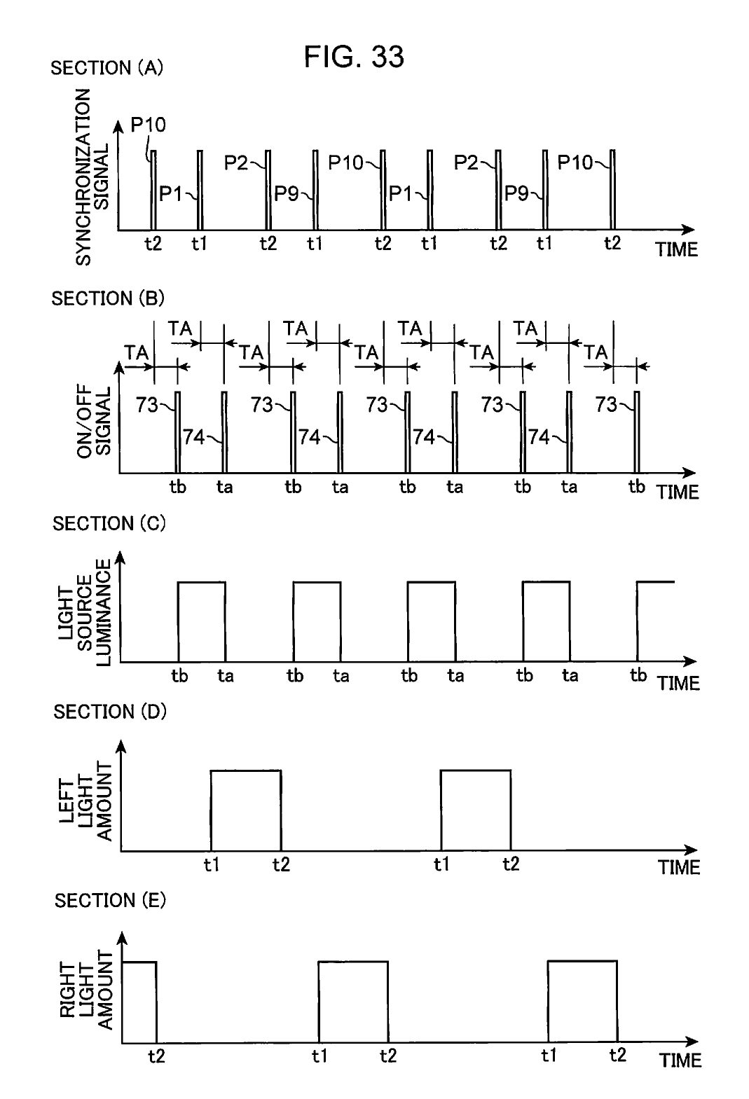

FIG. 33 is a timing chart schematically showing the blinking control on the light source 21 performed by the illumination controller 20C in accordance with the eighth embodiment. The section (A) of FIG. 33 shows the synchronization signals sent from the display device 3A. The section (B) of FIG. 33 shows the on/off-signals generated by the first generator 242 of the illumination controller 20C. The section (C) of FIG. 33 shows a luminance of the light source 21. The section (D) of FIG. 33 shows variation in light amount which passes through the left filter 41 and reaches the viewer's left eye. The section (E) of FIG. 33 shows variation in light amount which passes through the right filter 42 and reaches the viewer's right eye. The blinking control on the light source 21 performed by the illumination controller 20C in accordance with the eighth embodiment is described with reference to FIGS. 4, 13, 17 and 18, FIGS. 29 to 31 and FIG. 33.

Like the seventh embodiment, the display portion 310 of the display device 3A sends the synchronization signals including the bit serials P1, P2, P9 and P10 as shown in the section (A) of FIG. 33. As described in the context of FIG. 18, the synchronization signals including the bit serials P1, P9 are used as the first synchronization signals in synchronism with the display starts of the frame images FL, FR, respectively. The synchronization signal including the bit serial P1 synchronizes with the display start of the left frame image FL. The synchronization signal including the bit serial P9 synchronizes with the display start of the right frame image FR. Similarly, the synchronization signals including the bit serials P2, P10 are used as the second synchronization signals in synchronism with the display ends of the frame images FL, FR, respectively. The synchronization signal including the bit serial P2 synchronizes with the display end of the left frame image FL. The synchronization signal including the bit serial P10 synchronizes with the display end of the right frame image FR. As described in the context of the fourth embodiment, the optical filter portion 43 increases or decreases the light amount transmitted to the viewer's left or right eye in response to each synchronization signal.

As described in the context of the fourth embodiment, the first analyzer 241 of the illumination controller 20C measures the reception time t1 of the first synchronization signal (the synchronization signal including the bit serial P1 or P9) and the reception time t2 of the second synchronization signal (the synchronization signal including the bit serial P2 or P10).

A fifth signal from the remote controller 6 includes fifth information on the viewers' or other users' requests. In the present embodiment, the reception time t1 of the first synchronization signal and the delay time TA from the reception time t2 of the second synchronization signal are used as the fifth information. The first analyzer 241 adds the delay time TA to the reception time t1 of the first synchronization signal, and calculates the time ta at which the off-signal 74 is generated. The first analyzer 241 also adds the delay time TA to the reception time t2 of the second synchronization signal, and calculates the time tb at which the on-signal 73 is generated. The first analyzer 241 determines a time period from the time ta calculated on the basis of the reception time t1 of the first synchronization signal to the time tb calculated on the basis of the reception time t2 of the second synchronization signal as the first period, during which the light source 21 is darkened. The first analyzer 241 further determines a time period from the subsequent time tb to the time ta as the second period, during which the light source 21 is brightened.

The first generator 242 generates the on-signal 73 at the time tb calculated on the basis of the reception time t2 of the second synchronization signal and the off-signal 74 at the time ta calculated on the basis of the reception time t1 of the first synchronization signal. The light source controller 243 controls the light source 21 in response to the on-signal 73 and the off-signal 74 generated by the first generator 242. The light source 21 is darkened during the first period and brightened during the second period according to the determination by the first analyzer 241.

As shown in FIG. 33, the delay time TA delays both the generation times of the on-signal 73 and the off-signal 74, so that the brightening time of the light source 21 is not changed. Therefore, it becomes less likely that other users than the viewer, who views the stereoscopic video provided by the display device 3A, perceive a change in brightness of the space R.

During the time period from the time t1 to the time ta, the light source 21 is brightened. Meanwhile, the left or right filter 41, 42 increases the light amount transmitted to the left or right eye. Therefore, the viewer may operate the remote controller 6 to lengthen or shorten the delay time TA, so that the viewer may adjust the degree of brightness/darkness of the viewing environment of the left and right frame images FL, FR.

The present embodiment also allows several viewers to independently adjust the environment for viewing the stereoscopic video displayed by the display device 3A, respectively. If one of the viewers adjusts the viewing environment of the stereoscopic video, other viewers may continue viewing the stereoscopic video without influence from the adjustment of the viewers' viewing environment.

The communication methodologies of the synchronization signals described in the context of the fourth embodiment are used in the description of the present embodiment. Alternatively, the communication methodologies of the synchronization signals described in the context of the other embodiments may be applied to the present embodiment. The blinking control described in the context of FIG. 33 may be achieved if the delay time included in the fifth signal sent from the remote controller 6 is added to generation time of the on-signal and the off-signal measured or calculated on the basis of the synchronization signals, the first to third signals and the luminance signal by the first analyzer 241 of the illumination controller 20C, which are described in the other embodiments.

In the series of the embodiments, during the first period determined by the first analyzer 241 of the illumination controller 20A, 20B or 20C, the light source 21 is continuously darkened. Alternatively, only in some time period of the first period, the light source 21 may be darkened. Similarly, during the second period determined by the first analyzer 241 of the illumination controller 20A, 20B or 20C, the light source 21 is continuously brightened. Alternatively, in some time period of the second period, the light source 21 may be brightened.

The novel and advantageous features described in the context of the series of the embodiments may be used in conjunction with other various improvements and changes. For example, by mounting and using image identification technologies in the display device 3A, the information on whether a viewer views a stereoscopic video or not may be sent to the illumination controller 20A, 20B or 20C. Unless the viewer views the stereoscopic video, the illumination controller 20A, 20B or 20C continuously brightens the light source 21. While the viewer views the stereoscopic video, the illumination controller 20A, 20B or 20C may also brighten the light source 21 in synchronism with the switching operation of the stereoscopic video according to any methodologies of the aforementioned embodiments.

The display device 3A described in the context of the series of the aforementioned embodiments alternately displays the left and right frame images FL, FR. Alternatively, a few left and/or right frame images FL, FR may be continuously displayed. In this case, the eyeglass device 4A or 4B operates the left and right filters 41, 42 in synchronization with displays of the left and right frame images FL, FR, respectively. Also in such embodiments, the illumination controller 20A, 20B or 20C brightens the light source 21 in synchronism with the switching operation between the frame images and darkens the light source 21 in synchronism with display of the left or right frame image FL, FR.

The aforementioned embodiments mainly include the following configurations.

An illumination controller in accordance with one aspect of the aforementioned embodiments includes: an acquisition portion configured to acquire timing information on a timing of a non-display period during which a display device switches a frame image of a stereoscopic video without displaying the frame image; and a control portion configured to brighten a light source for illuminating a space where the display device is situated in synchronism with the non-display period and to darken the light source in synchronism with a display period during which the frame image is displayed, based on the timing information.

According to the aforementioned configuration, the acquisition portion of the illumination controller acquires the timing information on the timing of the non-display period during which the display device switch the frame image of the stereoscopic video without displaying the frame image. The control portion of the illumination controller brightens the light source configured to illuminate the space where the display device is situated in synchronism with the non-display period on the basis of the timing information. Therefore, users without viewing the stereoscopic video feel that the space where the display device is situated is bright. The control portion of the illumination controller darkens the light source in synchronism with the display period in which the frame image is displayed on the basis of the timing information. Therefore, a viewer feels that the space where the display device is situated is dark while the viewer views the frame image. As a result, the viewer enjoys the vivid stereoscopic video. Thus, a suitable illumination environment is provided to the viewer viewing the stereoscopic video and other users.

In the aforementioned configuration, preferably, the acquisition portion includes a receiver configured to receive a synchronization signal in synchronism with display of the frame image, and the control portion determines a first period during which the light source is darkened and a second period during which the light source is brightened, based on the synchronization signal.

According to the aforementioned configuration, the receiver of the illumination controller receives a synchronization signal in synchronism with display of the frame image. As a result, the illumination controller acquires the timing information on the switching timing of the frame image. The control portion determines the first period during which the light source is darkened, and the second period in which the light source is brightened, on the basis of the synchronization signal. The control portion then darkens the light source configured to illuminate the space where the display device is situated in synchronism with display of the frame image whereas the control portion brightens the light source configured to illuminate the space where the display device is situated in synchronism with switching of the frame image. Thus, a suitable illumination environment is provided to the viewer viewing the stereoscopic video and other users.

In the aforementioned configuration, preferably, the receiver receives a first signal including first information on a display time period per frame image, and the control portion determines a time period from when the synchronization signal is received by the receiver to when the display time period per frame image passes as the first period to darken the light source during the first period.

According to the aforementioned configuration, the receiver receives the first signal including the first information on the display time period per frame image. The control portion determines the period from when the receiver receives the synchronization signal to when the display time period per frame image passes as the first period, during which the light source is darkened. Therefore, the viewer feels that the space where the display device is situated is dark. As a result, the viewer enjoys the vivid stereoscopic video.

In the aforementioned configuration, preferably, the control portion determines a time period from when the display time period per frame image passes to when a next synchronization signal is received by the receiver as the second period to brighten the light source during the second period.

According to the aforementioned configuration, the control portion determines the period from when the display time period per frame image passes to when the receiver receives the next synchronization signal as the second period. The control portion darkens the light source during second period. Therefore, the users without viewing the stereoscopic video feel the bright space where the display device is situated.

In the aforementioned configuration, preferably, the receiver receives a second signal including second information on a frame rate of the stereoscopic video, and the control portion determines the first and second periods based on the synchronization signal and the second information, and controls the light source so that the light source is darkened during the first period whereas the light source is brightened during the second period.

According to the aforementioned configuration, the receiver receives the second signal including second information on the frame rate. The control portion acquires the timing information on the switching timing of the frame image on the basis of the second information and the reception of the synchronization signal, so that the control portion determines the first and second periods. In the first period, the control portion darkens the light source configured to illuminate the space where the display device is situated in synchronism with the display period. In the second period, the control portion brightens the light source configured to illuminate the space where the display device is situated in synchronism with the non-display period. Thus, a suitable illumination environment is provided to the viewer viewing the stereoscopic video and other users.

In the aforementioned configuration, preferably, the synchronization signal includes first information on a display time period per frame image, and the control portion determines a time period from when the synchronization signal is received to when the display time period per frame image passes as the first period to darken the light source during the first period.

According to the aforementioned configuration, the receiver receives the synchronization signal including the first information on the display time period per frame image. The control portion determines the time period from when the receiver receives the synchronization signal to when the display time period per frame image passes as the first period, during which the light source is darkened. Therefore, the viewer feels the dark space where the display device is situated. As a result, the viewer enjoys the vivid stereoscopic video.

In the aforementioned configuration, preferably, the synchronization signal includes information on a time period from when the display period per frame image passes to when a next frame image is started to display, the control portion determines a time period from when the display period per frame image ends to when the next frame image is started to display as the second period to brighten the light source during the second period.

According to the aforementioned configuration, the synchronization signal includes information on the time period from when the display period per frame image passes to when the next frame image is started to display. The control portion determines a time period from when the display period per frame image passes to when the next frame image is started to display as the second period. The control portion brightens the light source during the second period. Therefore, users without viewing the stereoscopic video feel the bright space where the display device is situated. Thus, a suitable illumination environment is provided to the viewer viewing the stereoscopic video and other users.

In the aforementioned configuration, preferably, the synchronization signal includes a first synchronization signal in synchronism with a display start of the frame image and a second synchronization signal in synchronism with a display end of the frame image, and the control portion determines a time period from when the first synchronization signal is received to when the second synchronization signal is received by the receiver as the first period to darken the light source during the first period.

According to the aforementioned configuration, the control portion determines the time period from when the first synchronization signal in synchronism with the display start of the frame image is received to when the second synchronization signal in synchronism with the display end of the frame image is received by the receiver as the first period. Thus, the viewer feels the dark space where the display device is situated while the viewer views the frame image because the light source is darkened. As a result, the viewer enjoys the vivid stereoscopic video.

In the aforementioned configuration, preferably, the control portion determines a time period from when the second synchronization signal is received to when a next first synchronization signal is received by the receiver as the second period to brighten the light source during the second period.

According to the aforementioned configuration, the control portion determines the time period from when the second synchronization signal is received to when the next first synchronization signal is received by the receiver as the second period. The control portion brightens the light source during the second period. Therefore, users without viewing the stereoscopic video feel the bright space where the display device is situated. During the second period, the light amount transmitted to the viewer's eye is reduced. Therefore, the light source brightened during the second period becomes less influential to the video perceived by the viewer. Thus, a suitable illumination environment is provided to the viewer viewing the stereoscopic video and other users.

In the aforementioned configuration, preferably, the receiver receives a third signal from an eyeglass device including an optical filter portion configured to allow a viewer to stereoscopically perceive the stereoscopic video displayed by the display device, the third signal including third information on timings at which the optical filter portion performs stereoscopic vision assistance to increase a light amount transmitted to the viewer's eye in synchronism with a display start of the frame image and decrease the light amount in synchronism with a display end of the frame image, and the control portion determines a time period from when the synchronization signal is received to when the third signal is received as the first period to darken the light source during the first period.

According to the aforementioned configuration, the eyeglass device includes an optical filter portion configured to perform stereoscopic vision assistance to allow the viewer to stereoscopically perceive the stereoscopic video. During the stereoscopic vision assistance, the optical filter portion increases the light amount transmitted to the viewer's eye in synchronism with the display start of the frame image, and decreases the light amount in synchronism with the display end of the frame image. The control portion receives a third signal from the eyeglass device. The third signal includes the third information on the timing at which the optical filter portion decreases the light amount. The control portion determines the time period from when the synchronization signal is received to when the third signal is received as the first period. Thus, the viewer feels the dark space where the display device is situated while the viewer views the frame image because the light source is darkened. As a result, the viewer enjoys the vivid stereoscopic video.

In the aforementioned configuration, preferably, the control portion determines a time period from when the third signal is received to when a next synchronization signal is received as the second period to brighten the light source during the second period.

According to the aforementioned configuration, the control portion determines the time period from when the third signal is received to when the synchronization signal is received by the receiver as the second period. The control portion brightens the light source during the second period. Therefore, the users without viewing the stereoscopic video feel the bright space where the display device is situated. During the second period, the light amount transmitted to the viewer's eye is decreased. Therefore, the light source brightened during the second period becomes less influential to the video perceived by the viewer. Thus, a suitable illumination environment is provided to the viewer viewing the stereoscopic video and other users.

In the aforementioned configuration, preferably, the acquisition portion includes a detector configured to detect a luminance of a display portion of the display device which displays the stereoscopic video, and the control portion determines a time period during which the luminance of the display portion is higher than a threshold value determined for the luminance as the first period, during which the light source is darkened, and determines a time period during which the luminance of the display portion is lower than the threshold value as the second period, during which the light source is brightened.

According to the aforementioned configuration, the detector of the illumination controller detects the luminance of the display portion of the display device which displays the stereoscopic video. The control portion determines the time period, during which the luminance of the display portion is higher than a threshold value that is determined for the luminance, as the first period, during which the light source is darkened. The control portion further determines the time period, during which the luminance of the display portion is lower than the threshold value, as the second period, during which the light source is brightened. Thus, a suitable illumination environment is provided to the viewer viewing the stereoscopic video and other users.

In the aforementioned configuration, preferably, the acquisition portion includes a request receiver configured to receive a fourth signal including fourth information on a viewer's request for a length of the second period, and the control portion adjusts a length of the brightening time of the light source based on the fourth information.

According to the aforementioned configuration, the viewer may adjust a degree of the brightness/darkness of the space during the time period during which the frame image is displayed.

In the aforementioned configuration, preferably, the acquisition portion includes a request receiver configured to receive a fifth signal including fifth information on a viewer's request for a time length from when the synchronization signal is received to when the second period starts, and the control portion adjusts a timing at which the light source is started to brighten based on the fifth information.

According to the aforementioned configuration, the viewer may adjust the degree of the brightness/darkness of the space during the time period, in which the frame image is displayed. Meanwhile other users existing in the space where the display device is situated may not perceive a change in degree of the brightness/darkness of the space.

An illuminator in accordance with another aspect of the aforementioned embodiment is characterized by including a light source configured to illuminate a space where a display device that displays a stereoscopic video is situated, and the aforementioned illumination controller.

According to the aforementioned configuration, the illuminator includes the light source and the illumination controller. Therefore, a suitable illumination environment is provided to a viewer viewing the stereoscopic video and other users.

An illumination system in accordance with another aspect of the aforementioned embodiment is characterized by including a display device including a display portion configured to display a stereoscopic video, and the aforementioned illuminator.

According to the aforementioned configuration, the illumination system includes the display device including a display portion configured to display a stereoscopic video, and the illuminator. Therefore, a suitable illumination environment is provided to the viewer viewing the stereoscopic video and other users.

A display device in accordance with yet another aspect of the aforementioned embodiment is characterized by including a display portion configured to display a stereoscopic video, and a first transmitter configured to send a synchronization signal to the illumination controller according to claim 1 in order to control a light source for illuminating a space where the display device is situated, so that the light source is brightened in synchronism with a non-display period during which a frame image of the stereoscopic video is switched without being displayed whereas the light source is darkened in synchronism with a display period during which the frame image is displayed.

According to the aforementioned configuration, the first tramsmitter of the display device sends the synchronization signal in synchronism with the display of the frame image of the stereoscopic video displayed by the display portion to the illumination controller. The illumination controller controls the light source configured to illuminate the space where the display device is situated so that the light source is brightened in synchronism with the switching of the frame image and so that the light source is darkened in synchronism with the display of the frame image. Therefore, users without viewing the stereoscopic video feel the bright space where the display device is situated whereas the viewer feels the dark space where the display device is situated while the viewer views the frame image. As a result, the viewer enjoys the vivid stereoscopic video. Thus, a suitable illumination environment is provided to the viewer viewing the stereoscopic video and the other users.

An eyeglass device in accordance with yet another aspect of the embodiment is characterized by including an optical filter portion configured to perform stereoscopic vision assistance to adjust a light amount transmitted to an eye of a viewer in synchronism with display of a frame image of a stereoscopic video displayed by a display device so as to allow the viewer to stereoscopically perceive the stereoscopic video, wherein the optical filter portion increases the light amount transmitted to the viewer's eye in synchronism with a timing at which the illumination controller according to claim 1 darkens the light source.

According to the aforementioned configuration, the eyeglass device increases the light amount transmitted to the viewer's eyes in synchronism with the timing at which the illumination controller darkens the light source. Therefore, the viewer feels the dark space where the display device is situated while the viewer views the frame image. As a result, the viewer enjoys the vivid stereoscopic video.

### INDUSTRIAL APPLICABILITY

The present invention is preferably applicable to illumination facilities configured to illuminate any spaces.

1. An illumination controller comprising:
an acquisition portion configured to acquire timing information on a timing of a non-display period during which a display device switches a frame image of a stereoscopic video without displaying the frame image; and
a control portion configured to brighten a light source for illuminating a space where the display device is situated in synchronism with the non-display period and to darken the light source in synchronism with a display period during which the frame image is displayed, based on the timing information.

2. The illumination controller according to claim 1, wherein
the acquisition portion includes a receiver configured to receive a synchronization signal in synchronism with display of the frame image, and
the control portion determines a first period during which the light source is darkened and a second period during which the light source is brightened, based on the synchronization signal.

3. The illumination controller according to claim 2, wherein
the receiver receives a first signal including first information on a display time period per frame image, and
the control portion determines a time period from when the synchronization signal is received by the receiver to when the display time period per frame image passes as the first period to darken the light source during the first period.

4. The illumination controller according to claim 3, wherein the control portion determines a time period from when the display time period per frame image passes to when a next synchronization signal is received by the receiver as the second period to brighten the light source during the second period.

5. The illumination controller according to claim 2, wherein
the receiver receives a second signal including second information on a frame rate of the stereoscopic video, and
the control portion determines the first and second periods based on the synchronization signal and the second information, and controls the light source so that the light source is darkened during the first period whereas the light source is brightened during the second period.

6. The illumination controller according to claim 2, wherein
the synchronization signal includes first information on a display time period per frame image, and
the control portion determines a time period from when the synchronization signal is received to when the display time period per frame image passes as the first period to darken the light source during the first period.

7. The illumination controller according to claim 2, wherein
the synchronization signal includes information on a time period from when the display period per frame image passes to when a next frame image is started to display,
the control portion determines a time period from when the display period per frame image ends to when the next frame image is started to display as the second period to brighten the light source during the second period.

8. The illumination controller according to claim 2, wherein
the synchronization signal includes a first synchronization signal in synchronism with a display start of the frame image and a second synchronization signal in synchronism with a display end of the frame image, and
the control portion determines a time period from when the first synchronization signal is received to when the second synchronization signal is received by the receiver as the first period to darken the light source during the first period.

9. The illumination controller according to claim 8, wherein the control portion determines a time period from when the second synchronization signal is received to when a next first synchronization signal is received by the receiver as the second period to brighten the light source during the second period.

10. The illumination controller according to claim 2, wherein
the receiver receives a third signal from an eyeglass device including an optical filter portion configured to allow a viewer to stereoscopically perceive the stereoscopic video displayed by the display device, the third signal including third information on timings at which the optical filter portion performs stereoscopic vision assistance to increase a light amount transmitted to the viewer's eye in synchronism with a display start of the frame image and decrease the light amount in synchronism with a display end of the frame image, and
the control portion determines a time period from when the synchronization signal is received to when the third signal is received as the first period to darken the light source during the first period.

11. The illumination controller according to claim 10, wherein the control portion determines a time period from when the third signal is received to when a next synchronization signal is received as the second period to brighten the light source during the second period.

12. The illumination controller according to claim 1, wherein
the acquisition portion includes a detector configured to detect a luminance of a display portion of the display device which displays the stereoscopic video, and
the control portion determines a time period during which the luminance of the display portion is higher than a threshold value determined for the luminance as the first period, during which the light source is darkened, and determines a time period during which the luminance of the display portion is lower than the threshold value as the second period, during which the light source is brightened.

13. The illumination controller according to claim 2, wherein
the acquisition portion includes a request receiver configured to receive a fourth signal including fourth information on a viewer's request for a length of the second period, and
the control portion adjusts a length of the brightening time of the light source based on the fourth information.

14. The illumination controller according to claim 2, wherein
the acquisition portion includes a request receiver configured to receive a fifth signal including fifth information on a viewer's request for a time length from when the synchronization signal is received to when the second period starts, and
the control portion adjusts a timing at which the light source is started to brighten based on the fifth information.

15. An illuminator, comprising:
a light source configured to illuminate a space where a display device that displays a stereoscopic video is situated, and
the illumination controller according to claim 1.

16. An illumination system, comprising:
a display device including a display portion configured to display a stereoscopic video, and the illuminator according to claim 15.

17. A display device, comprising:
a display portion configured to display a stereoscopic video, and
a first transmitter configured to send a synchronization signal to the illumination controller according to claim 1 in order to control a light source for illuminating a space where the display device is situated, so that the light source is brightened in synchronism with a non-display period during which a frame image of the stereoscopic video is switched without being displayed whereas the light source is darkened in synchronism with a display period during which the frame image is displayed.

18. An eyeglass device comprising:
an optical filter portion configured to perform stereoscopic vision assistance to adjust a light amount transmitted to an eye of a viewer in synchronism with display of a frame image of a stereoscopic video displayed by a display device so as to allow the viewer to stereoscopically perceive the stereoscopic video, wherein
the optical filter portion increases the light amount transmitted to the viewer's eye in synchronism with a timing at which the illumination controller according to claim 1 darkens the light source.
